(19) United States
(12) Patent Application Publication
(10) Pub. No.: US 2018/0196885 A1
(43) Pub. Date: Jul. 12, 2018

(54) METHOD FOR SHARING DATA AND AN ELECTRONIC DEVICE THEREOF

(71) Applicant: Samsung Electronics Co., Ltd, Suwon-si (KR)

(72) Inventors: Kyung-Tae KIM, Suwon-si (KR); Yoon-Jeong CHOI, Seoul (KR); Hye-Rim BAE, Suwon-si (KR); Sungmin YOON, Suwon-si (KR); Jung-Jik LEE, Suwon-si (KR); Chang-Ho LEE, Suwon-si (KR); Changhyup JWA, Suwon-si (KR)

(21) Appl. No.: 15/863,332

(22) Filed: Jan. 5, 2018

(30) Foreign Application Priority Data
Jan. 6, 2017 (KR) 10-2017-0002206

(51) Int. Cl. G06F 17/30; G06F 17/22

(52) U.S. Cl. CPC G06F 17/30887; G06F 17/2247; G06F 17/3089

(57) ABSTRACT

According to various embodiments of the present disclosure, an electronic device can include a display, a communication circuit, a processor coupled to the communication circuit and the display, and a memory coupled to the processor. The memory can store instructions, when executed, controlling the processor to receive data of a webpage through the communication circuit, to display the webpage through the display, to receive an event on the webpage, to generate data comprising information for generating the webpage, event information of the webpage, and event time information, and to transmit the generated data through the communication circuit.

### CROSS-REFERENCE TO RELATED APPLICATION(S) AND CLAIM OF PRIORITY

The present application is related to and claims priority under 35 U.S.C. § 119(a) to Korean Patent Application No. 10-2017-0002206 filed on Jan. 6, 2017, the entire disclosure of which is hereby incorporated by reference.

### TECHNICAL FIELD

The present disclosure relates to a method and an electronic device for sharing data.

### BACKGROUND

As User Created Contents (UCCs) are prevailing, a user provides his/her own data to other users in various sharing manners. Among the various sharing methods, screen mirroring or game cast allows to share the same screen of the user with the user others.

Various data such as applications or games are provided in HyperText Markup Language (HTML) but are shared based on a Uniform Resource Locator (URL) or a screen image of a browser. When a webpage is shared, a video uses considerate data transmission traffic. When a bandwidth for the transmission is not ensured, the video can be interrupted or degraded in quality.

### SUMMARY

To address the above-discussed deficiencies, it is a primary object to provide a method and an electronic device for sharing a webpage.

According to one aspect of the present disclosure, an electronic device can include a display, a communication circuit, a processor coupled to the communication circuit and the display, and a memory coupled to the processor. The memory can store instructions, when executed, controlling the processor to receive data of a webpage through the communication circuit, to display the webpage through the display, to receive an event on the webpage, to generate data including information for generating the webpage, event information of the webpage, and event time information, and to transmit the generated data through the communication circuit.

According to another aspect of the present disclosure, an electronic device can include a display, a communication circuit, a processor coupled to the communication circuit and the display, and a memory coupled to the processor. The memory can store instructions, when executed, controlling the processor to receive data including information for generating the webpage, event information on the webpage, and event time information from other electronic device through the communication circuit, to generate a webpage based on the data, and to apply the event to the webpage according to the event time of the data.

According to yet another aspect of the present disclosure, a system for sharing a webpage can include a first electronic device for storing an event of the webpage, a second electronic device for processing the event of the webpage, and a server connected to the first electronic device and the second electronic device. The first electronic device can display the webpage, generate data including information for generating the webpage, event information of the webpage, and event time information, and transmit the generated data to the server. The server can receive the data from the first electronic device and transmits the data to the second electronic device. The second electronic device can receive the data from the server, generates a webpage based on the data, and processes the event on the webpage according to the event time of the data.

Other aspects, advantages, and salient features of this disclosure will become apparent to those skilled in the art from the following detailed description, which, taken in conjunction with the annexed drawings, discloses exemplary embodiments of this disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 illustrates a network environment for webpage sharing according to various embodiments of the present disclosure;

FIG. 5 illustrates a functional structure of an electronic device according to various embodiments of the present disclosure;

FIGS. 6A and 6B illustrate operations for sharing a webpage according to various embodiments of the present disclosure;

FIGS. 7A and 7B illustrate operations for sharing a webpage via a server in real time according to various embodiments of the present disclosure;

FIGS. 8A and 8B illustrate operations for sharing a webpage using an owned server according to various embodiments of the present disclosure;

FIG. 9A illustrates a flowchart of a webpage sharing method in an electronic device according to various embodiments of the present disclosure;

FIG. 9B illustrates operations for processing a webpage according to various embodiments of the present disclosure;

FIG. 10A illustrates a flowchart of a method for generating data for webpage sharing in an electronic device according to various embodiments of the present disclosure;

FIG. 10B illustrates data generation for webpage sharing based on time in an electronic device according to various embodiments of the present disclosure;

FIG. 10C illustrates a Document Object Model (DOM) tree and a render tree according to various embodiments of the present disclosure;

FIG. 11 illustrates a flowchart of a method for generating a file including data for webpage sharing in an electronic device according to various embodiments of the present disclosure;

FIG. 12 illustrates a flowchart of a method for providing data for webpage sharing to another electronic device via an external server in an electronic device according to various embodiments of the present disclosure;

FIG. 13 illustrates a flowchart of a method for providing data for webpage sharing to another electronic device via an owned server in an electronic device according to various embodiments of the present disclosure;

FIG. 14 illustrates a flowchart of a method for processing a webpage event of another electronic device in an electronic device according to various embodiments of the present disclosure;

FIG. 15 illustrates a flowchart of a method for receiving data for webpage sharing of another electronic device via an external server in an electronic device according to various embodiments of the present disclosure;

FIG. 16 illustrates a flowchart of a method for receiving data for webpage sharing of another electronic device via an owned server of the other electronic device in an electronic device according to various embodiments of the present disclosure;

FIG. 17 illustrates a flowchart of a method for processing webpage sharing data of another electronic device in an electronic device according to various embodiments of the present disclosure;

FIG. 18 illustrates a flowchart of a method for setting a layout of a webpage in an electronic device according to various embodiments of the present disclosure;

FIG. 19 illustrates a screen for processing a webpage event in chronological order in an electronic device according to various embodiments of the present disclosure;

FIG. 20 illustrates a screen for processing a webpage event based on a user input in an electronic device according to various embodiments of the present disclosure;

FIG. 21 illustrates a screen for processing a webpage event based on screen resolution control of an electronic device according to various embodiments of the present disclosure;

FIG. 22 illustrates another screen for displaying a webpage based on screen resolution control of an electronic device according to various embodiments of the present disclosure;

FIG. 23 illustrates a screen for processing a webpage event based on dynamic screen resolution control of an electronic device according to various embodiments of the present disclosure;

FIG. 24A illustrates operations for interactions when an electronic device and another electronic device share a webpage screen according to various embodiments of the present disclosure;

FIG. 24B illustrates an interface indicating whether other electronic devices joining in webpage sharing of an electronic device are synchronized or not according to various embodiments of the present disclosure;

FIG. 24C illustrates an interface for exchanging chatting messages between sharers in webpage sharing of an electronic device according to various embodiments of the present disclosure; and

FIG. 24D illustrates control management between an electronic device and other electronic devices in webpage sharing of the electronic device according to various embodiments of the present disclosure.

Throughout the drawings, like reference numerals will be understood to refer to like parts, components and structures.

### DETAILED DESCRIPTION

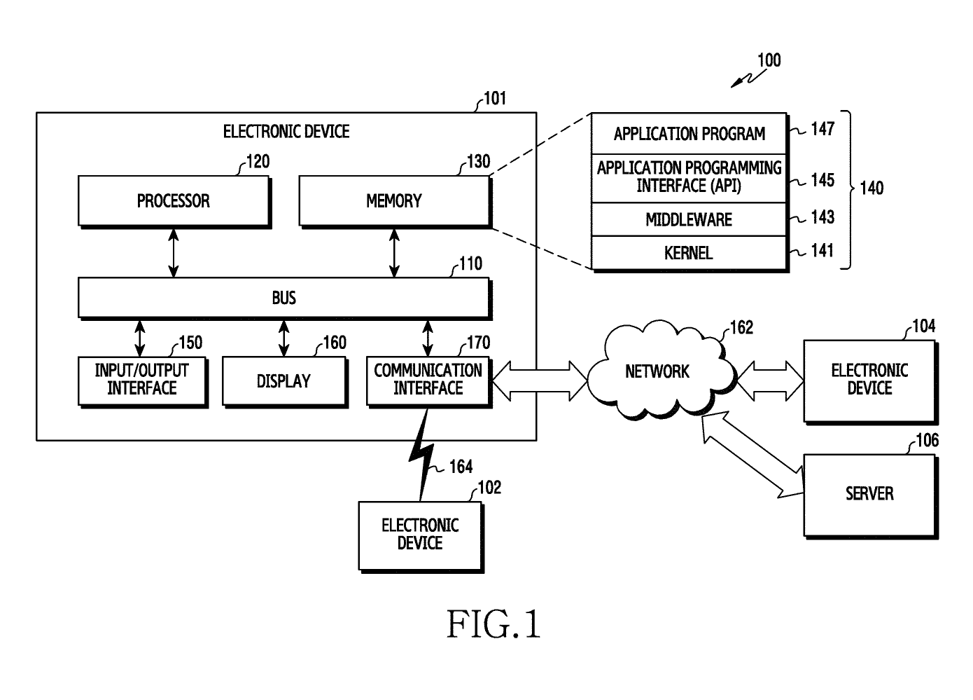

FIGS. 1 through 24D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various example embodiments of the present disclosure will be described with reference to the accompanying drawings. However, it should be understood that there is no intent to limit the present disclosure to the particular forms disclosed herein; rather, the present disclosure should be understood to cover various modifications, equivalents, and/or alternatives of the various example embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. On the other hand, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer, for example, to a situation in which the device, together with other devices or components, “is able to”. For example, the phrase “processor adapted (or configured) to perform A, B, and C” may refer, for example, to a dedicated processor (e.g. embedded processor) for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even when the term is defined in the present disclosure, it should not be interpreted to exclude embodiments of the present disclosure.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various example embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto.

According to some example embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various example embodiments of the present disclosure may be a combination of one or more of the aforementioned various devices. The electronic device according to some embodiments of the present disclosure may be a flexible device. Further, the electronic device according to an example embodiment of the present disclosure is not limited to the aforementioned devices, and may include a new electronic device according to the development of technology.

Hereinafter, an electronic device according to various example embodiments will be described with reference to the accompanying drawings. As used herein, the term “user” may indicate a person who uses an electronic device or a device (e.g., an artificial intelligence electronic device) that uses an electronic device.

FIG. 1 illustrates a diagram of an example network environment including an example electronic device according to various example embodiments of the present disclosure.

An electronic device 101 within a network environment 100, according to various embodiments, will be described with reference to FIG. 1. The electronic device 101 may include a bus 110, a processor (e.g., including processing circuitry) 120, a memory 130, an input/output interface (e.g., including interface circuitry) 150, a display 160, and a communication interface (e.g., including communication circuitry) 170. In some embodiments, the electronic device 101 may omit at least one of the above elements or may further include other elements.

The bus 110 may include, for example, a circuit for connecting the elements 110-170 and transferring communication (e.g., control messages and/or data) between the elements.

The processor 120 may include various processing circuitry, such as, for example, and without limitation, one or more of a dedicated processor, a Central Processing Unit (CPU), an Application Processor (AP), and a Communication Processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more operation requests received from the application program 147 according to priority. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may include various interface circuitry and function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display, or the like, but is not limited thereto. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may include various communication circuitry and set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may be performed by using at least one of, for example, Wi-Fi, Bluetooth, Bluetooth low energy (BLE), Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of a communication network such as a computer network (e.g., a LAN or a WAN), the Internet, and a telephone network.

Each of the first and second external electronic apparatuses 102 and 104 may be of a type identical to or different from that of the electronic device 101. According to an embodiment, the server 106 may include a group of one or more servers. According to various embodiments, all or some of the operations performed in the electronic device 101 may be performed in another electronic device or a plurality of electronic devices (e.g., the electronic devices 102 and 104 or the server 106). According to an embodiment, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic apparatus may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

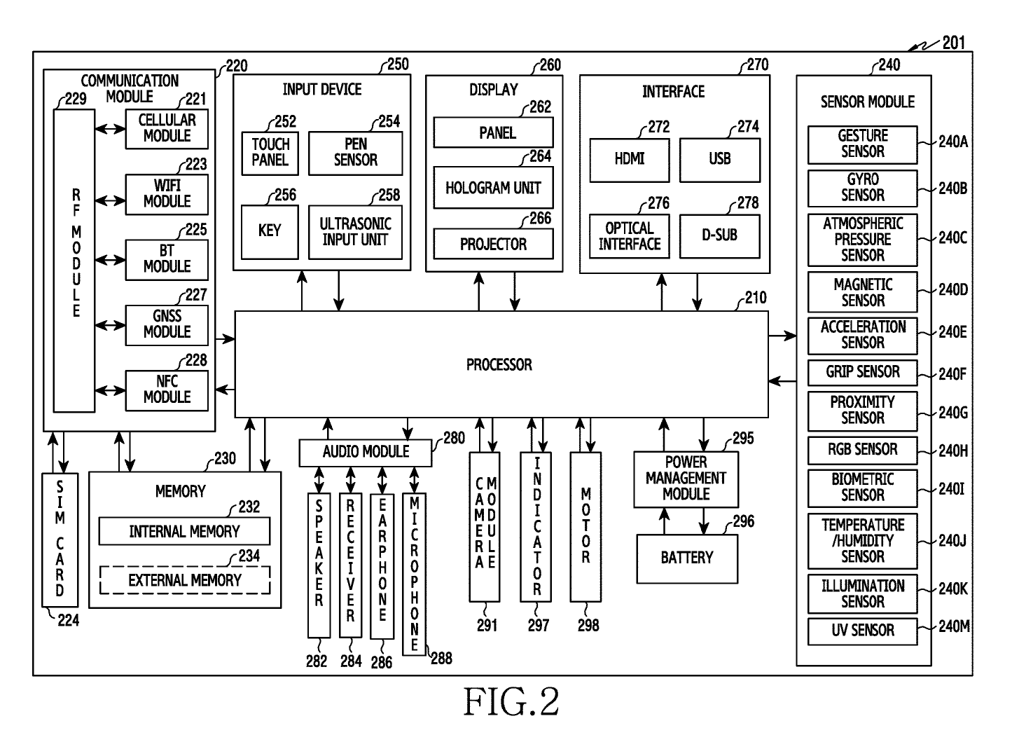

FIG. 2 illustrates a block diagram of an example electronic device according to various example embodiments of the present disclosure.

FIG. 2 illustrates a block diagram of an electronic device 201 according to various example embodiments. For example, the electronic device 201 may include the whole or part of the electronic device 101 illustrated in FIG. 1. The electronic device 201 may include at least one processor (e.g., Application Processor (AP)) (e.g., including processing circuitry) 210, a communication module (e.g., including communication circuitry) 220, a Subscriber Identification Module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may include various processing circuitry and control a plurality of hardware or software components connected to the processor 210 by driving an operating system or an application program and perform processing of various pieces of data and calculations. The processor 210 may be implemented by, for example, a System on Chip (SoC). According to an embodiment, the processor 210 may further include a Graphic Processing Unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include various communication circuitry, such as, for example, and without limitation, the cellular module 221, a Wi-Fi module 223, a Bluetooth (BT) module 225, a GNSS module 227 (e.g., a GPS module, a Glonass module, a Beidou module, or a Galileo module), an NFC module 228, and a Radio Frequency (RF) module 229.

The cellular module 221 may provide a voice call, image call, a text message service, or an Internet service through, for example, a communication network. According to an embodiment, the cellular module 221 may distinguish between and authenticate electronic devices 201 within a communication network using a subscriber identification module (for example, the SIM card 224). According to an embodiment of the present disclosure, the cellular module 221 may perform at least some of the functions that the processor 210 may provide. According to an embodiment, the cellular module 221 may include a Communication Processor (CP).

Each of the Wi-Fi module 223, the BT module 225, the GNSS module 227, and the NFC module 228 may include, for example, a processor for processing data transmitted and received through the relevant module. According to some embodiments of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229 may transmit/receive, for example, a communication signal (for example, an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the GNSS module 227, and the NFC module 228 may transmit and receive RF signals through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (for example, the memory 130) may include, for example, an internal memory 232 and/or an external memory 234. The embedded memory 232 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 may be functionally and/or physically connected to the electronic device 201 through various interfaces.

The sensor module 240 may measure a physical quantity or detect an operation state of the electronic device 201, and may convert the measured or detected information into an electrical signal. For example, the sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 240I, a temperature/humidity sensor 240J, a light sensor 240K, and an Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments of the present disclosure, the electronic device 201 may further include a processor configured to control the sensor module 240 as a part of or separately from the processor 210, and may control the sensor module 240 while the processor 210 is in a sleep state.

The input device 250 may include various input circuitry, such as, for example, and without limitation, a touch panel 252, a (digital) pen sensor 254, a key 256, or an ultrasonic input device 258. The touch panel 252 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic device 201. According to an embodiment, the display 260 may further include a control circuit for controlling the panel 262, the hologram device 264, or the projector 266.

The interface 270 may include various interface circuitry, such as, for example, and without limitation, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some elements of the audio module 280 may be included in, for example, the input/output interface 150 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 295 may manage, for example, power of the electronic device 201. According to an embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic device 201 or a part (e.g., the processor 210). The motor 298 may convert an electrical signal into mechanical vibration, and may generate vibration, a haptic effect, or the like. Although not illustrated, the electronic device 201 may include a processing unit (e.g., a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

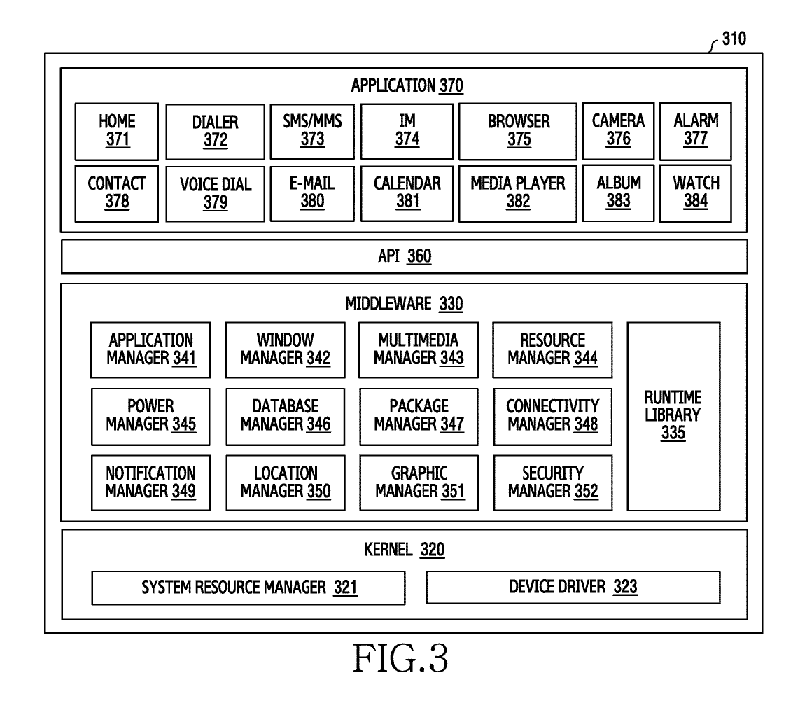

FIG. 3 illustrates a block diagram of an example program module according to various example embodiments of the present disclosure.

According to an embodiment, the program module 310 (for example, the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic apparatus, or may be downloaded from an external electronic apparatus (e.g., the electronic device 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function used by the applications 370 in common or provide various functions to the applications 370 through the API 360 so that the applications 370 can efficiently use limited system resources within the electronic device. According to an example embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage Graphical User Interface (GUI) resources used for the screen. The multimedia manager 343 may determine a format used to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a Basic Input/Output System (BIOS) to manage a battery or power and may provide power information used for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic apparatus. The graphic manager 351 may manage a graphic effect, which is to be provided to the user, or a user interface related to the graphic effect. The security manager 352 may provide various security functions used for system security, user authentication, and the like. According to an embodiment of the present disclosure, when the electronic apparatus (e.g., the electronic device 101) has a telephone call function, the middleware 330 may further include a telephony manager for managing a voice call function or a video call function of the electronic apparatus.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application program 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic apparatus (e.g., the electronic device 101) and an external electronic apparatus (e.g., the electronic device 102 or 104). The application associated with information exchange may include, for example, a notification relay application for forwarding specific information to an external electronic device, or a device management application for managing an external electronic device.

For example, the notification relay application may include a function of delivering, to the external electronic apparatus (e.g., the electronic device 102 or 104), notification information generated by other applications (e.g., an SMS/MMS application, an email application, a health care application, an environmental information application, etc.) of the electronic device 101. Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment, the applications 370 may include applications (for example, a health care application of a mobile medical appliance or the like) designated according to attributes of the external electronic device 102 or 104. According to an embodiment of the present disclosure, the application 370 may include an application received from the external electronic apparatus (e.g., the server 106, or the electronic device 102 or 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, refer to a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module’ may be a minimum unit for performing one or more functions or a part thereof. The “module” may be mechanically or electronically implemented. For example, the “module” according to the present disclosure may include at least one of a dedicated processor, a CPU, an Application-Specific Integrated Circuit (ASIC) chip, a Field-Programmable Gate Arrays (FPGA), and a programmable-logic device for performing operations which has been known or are to be developed hereinafter.

According to various example embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

Hereinafter, various embodiments of the present disclosure provide an electronic device and a method for storing and processing an event of a webpage. The webpage is a document written to provide information to a user on Internet, and one webpage can be linked to other webpage using an internal link. The webpage can include at least one object. For example, the at least one object can include a text and a multimedia object such as image, sound, or video.

According to various embodiments of the present disclosure, a web browser can be an application program stored in a memory of the electronic device and executed by a processor to output a webpage. The web browser can generate and display a webpage from a resource of the webpage, and conduct various functions for the webpage. The web browser can store data about an event of a user input on the webpage. Based on the data of the event on the webpage, the web browser can process the event on the webpage. The functions of the web browser for storing and displaying the webpage screen can be provided as unique functions of the web browser, and supported by plug-in of the webpage.

In this disclosure, the term ‘event’ used in storing and sharing a webpage event can indicate an operation which causes a change of the webpage screen displayed by an application (e.g., a web browser) according to a user input or the webpage itself. For example, the event can generate to be delivered to other device which shares the webpage. The event can change a visual element or a sound element. For example, the event on the webpage can include scroll, click, zoom-in, and zoom-out of the webpage. Also, the event can insert or change additional contents, such as memo insertion or voice recording, in storing and displaying the webpage.

In this disclosure, ‘storing’ the webpage event can indicate an operation which stores at least one webpage information output through the application (e.g., the web browser) and event information on the webpage. For example, storing the webpage event can generate information of at least one event to share. For example, storing the webpage event can include storing information for generating at least one webpage which is output through the application and the event information on the webpage, and creating a file for processing the event on the webpage through the application.

In this disclosure, ‘processing’ the webpage event can indicate an operation which processes the webpage and the event on the webpage so as to display the substantially same screen as the stored webpage event through the application. For example, the webpage event is processed by a device which stores the webpage event or a device which receives the webpage event, and can indicate processing at least one event according to information generated by storing the webpage event. For example, processing the webpage event can include analyzing the data generated by storing the webpage event, outputting the webpage through the application based on webpage generation information and the event information of the webpage from the analyzed data, and processing the event in the webpage.

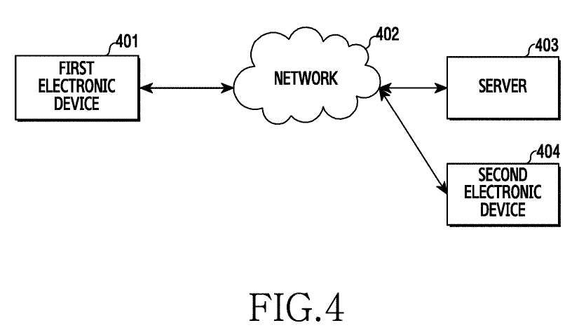

FIG. 4 illustrates a network environment for webpage sharing according to various embodiments of the present disclosure. Referring to FIG. 4, the network environment can include a first electronic device 401, a network 402, a server 403, and a second electronic device 404.

The first electronic device 401 or the second electronic device 404, which executes at least one function, can perform substantially the same or similar functions to the electronic device 101 of FIG. 1 or the electronic device 201 of FIG. 2. The first electronic device 401 can store event data of a webpage and share the webpage with another electronic device. The second electronic device 404 can receive the event data of the webpage from the first electronic device 401 and process the event of a corresponding webpage. To ease the understanding, the first electronic device 401 shares the webpage and the second electronic device 404 processes the event of the webpage. It is noted that the operations of the first electronic device 401 and the second electronic device 404 can be changed.

The network 402 is a communication path between communication entities and can be substantially the same or similar network to the network 162 of FIG. 1. The network 402 can forward data generated for processing the event of the webpage from the first electronic device 401 to the second electronic device 404. Without the network 402, the first electronic device 401 and the second electronic device 404 can perform Device-to-Device (D2D) communication via a direct link.

The server 403 can process relatively more data than a client device (e.g., the electronic device 101 of FIG. 1) and thus provide data to the client device. The server 403 can perform substantially the same or similar functions to the server 106 of FIG. 1. The server 403 can store the data for processing the webpage event, which is generated by the first electronic device 401. The server 403 can provide an environment enabling real-time webpage sharing between the first electronic device 401 and the second electronic device 404.

The server 403 can store data of the webpage which is output from the first electronic device 401. The server 403 can forward the stored webpage data of the first electronic device 401 to the second electronic device 404. The second electronic device 404 can process the webpage data (e.g., HyperText Markup Language (HTML) or video format) received from the server 403. The webpage sharing via the server 403 can be implemented using a cloud computing technology.

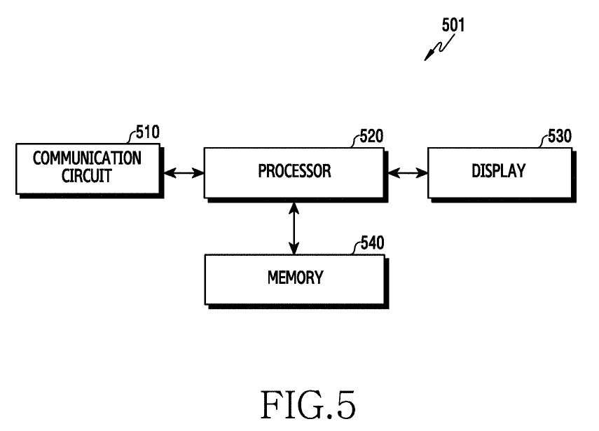

FIG. 5 illustrates a functional structure of an electronic device 501 according to various embodiments of the present disclosure. The electronic device 501 (e.g., the electronic device 101, 102, or 201) of FIG. 5 can include a communication circuit 510 (e.g., the communication interface 170 or the communication module 220), a processor 520 (e.g., an application processor), a display 530, and a memory 540 (e.g., the memory 130 or 230). The second electronic device 404 or the first electronic device 401 of FIG. 4 can have the same or similar configuration to the electronic device 501.

According to an embodiment, the communication circuit 510 can send or receive a signal to communicate with another electronic device (e.g., the second electronic device 404). The communication circuit 510 can include components for executing substantially the same or similar functions to the communication interface 170 of FIG. 1 or the communication module 220 of FIG. 2. The communication circuit 510 can be referred to as a transmitter, a receiver, a transceiver, or a communication module. The communication circuit 510 can send data for sharing a webpage generated by the processor 520, to the other electronic device (e.g., the second electronic device 404). The communication circuit 510 can receive data for sharing a webpage generated by the other electronic device (e.g., the first electronic device 401).

According to an embodiment, the processor 520 can process data of the electronic device 501 or control the components (e.g., the communication circuit 510) of the electronic device 501. The processor 520 can perform the same or similar functions to the processor 120 of FIG. 1 or the processor 210 of FIG. 2. The processor 520 can include one or more processors.

According to various embodiments of the present disclosure, the processor 520 can identify a webpage which is output from the electronic device 501 and an event relating to the webpage, and store data of the webpage event. According to an embodiment, the processor 520 can generate a file to be provided to another electronic device (e.g., the second electronic device 404 of FIG. 4) based on the stored information.

According to various embodiments of the present disclosure, the processor 520 can process the webpage event received from another electronic device (e.g., the first electronic device 401 of FIG. 4) through the communication circuit 510. The processor 520 can process the webpage event of the other electronic device (e.g., the first electronic device 401 of FIG. 4) through an application.

According to various embodiments of the present disclosure, the display 530 can display the webpage which is output through the application (e.g., the web browser). The display 530 can include a touch panel and detect a user's touch input. The display 530 can perform the same or similar functions to the display 160 of FIG. 1 or the display 260 of FIG. 2. The display 530 can display the webpage which is output through the application.

According to various embodiments of the present disclosure, the memory 540 can store data. The memory 540 can perform the same or similar functions to the memory 130 of FIG. 1 or the memory 230 of FIG. 2. The memory 540 can store the information received through the communication circuit 510 or the information generated by the processor 520. For example, the memory 540 can store information for generating the webpage displayed by the display 530 or event information on the webpage. The memory 540 can store data for processing the webpage event received through the communication circuit 510 or the information generated by the processor 520. For example, the information generated by the processor 520 can include information for rendering the webpage.

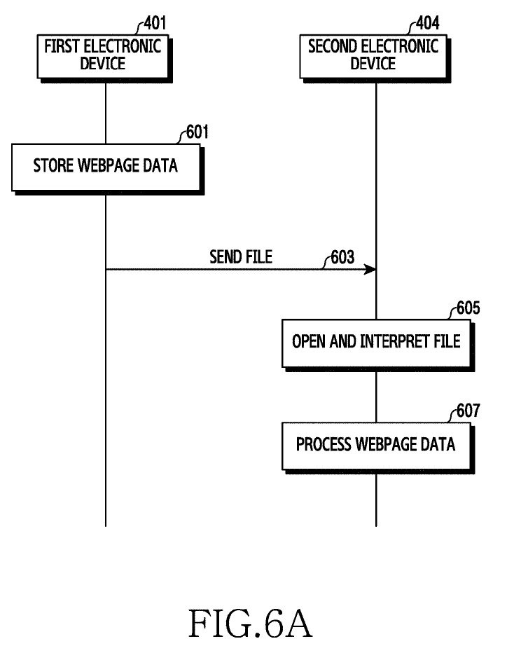

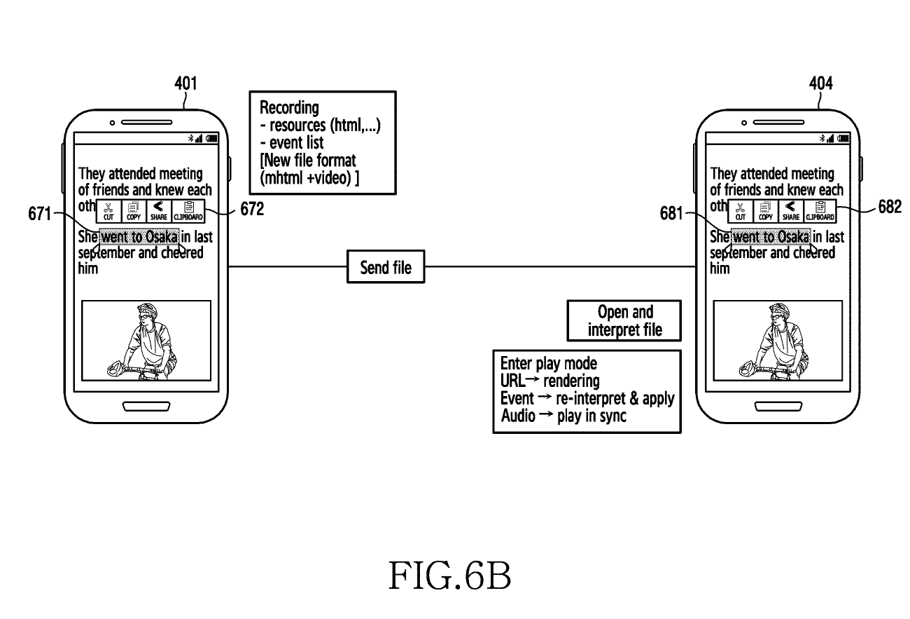

FIG. 6A illustrates operations for sharing a webpage according to various embodiments of the present disclosure. In FIG. 6A, a first electronic device (e.g., the first electronic device 401 of FIG. 4) stores event data of a webpage and provides a file generated by storing the event data to a second electronic device (e.g., the second electronic device 404 of FIG. 4).

Referring to FIG. 6A, in operation 601, the first electronic device 401 can store data for sharing a webpage displayed through an application (e.g., a web browser). The first electronic device 401 can generate data for processing the stored webpage event, as a file. For example, the generated file can include, as shown in FIG. 6B, information for generating the webpage (e.g., an html resource), event progress information (e.g., a script for the event on the webpage), and additional contents (e.g., a sound resource) for the event on the webpage. For example, referring to FIG. 6B, the file generated by the first electronic device 401 can include the webpage generation information, a text drag 671 as the event on the webpage, and information displaying editing tools 672 based on the drag. The file can be generated in a Multipurpose Internet Mail Extensions (MIME) html (mhtml) format including html elements and media data. The file generated by the first electronic device 401 can include formats of html, script, cascading style sheet (css), image, and sound.

In operation 603, the first electronic device 401 can send the file generated in operation 601 to the second electronic device 404. The first electronic device 401 can send the generated file to the second electronic device 404 using wireless communication or wired communication. For example, the first electronic device 401 can upload the file using the server 403 or a database of the network 402, and the second electronic device 404 can download the corresponding file. Alternatively, the first electronic device 401 send the file to the second electronic device 404 using a Peer-to-Peer (P2P) service or using short-range direct communication (e.g., Wi-Fi direct). The second electronic device 404 can receive the file including the event information of the webpage from the first electronic device 401.

In operation 605, the second electronic device 404 can process the file received from the first electronic device 401. For example, the second electronic device 404 can obtain a Uniform Resource Locator (URL) of the webpage and details of the stored event, from the file received to process the event on the webpage. The second electronic device 404 can obtain audio data or video data relating to the webpage of the stored event.

In operation 607, the second electronic device 404 can display the webpage of the first electronic device 401 based on the information obtained by processing the received file. For example, the second electronic device 404 can render and display the webpage acquired from the URL of the webpage using the application. The second electronic device 404 can interpret the event of the first electronic device 401 and apply the stored event to the rendered webpage. For example, the second electronic device 404 can display a drag 681 on a webpage text and editing tools 682 based on the drag, on the webpage using the application as shown in FIG. 6B. The second electronic device 404 can synchronize and process an audio file of the received file according to the time of the stored event.

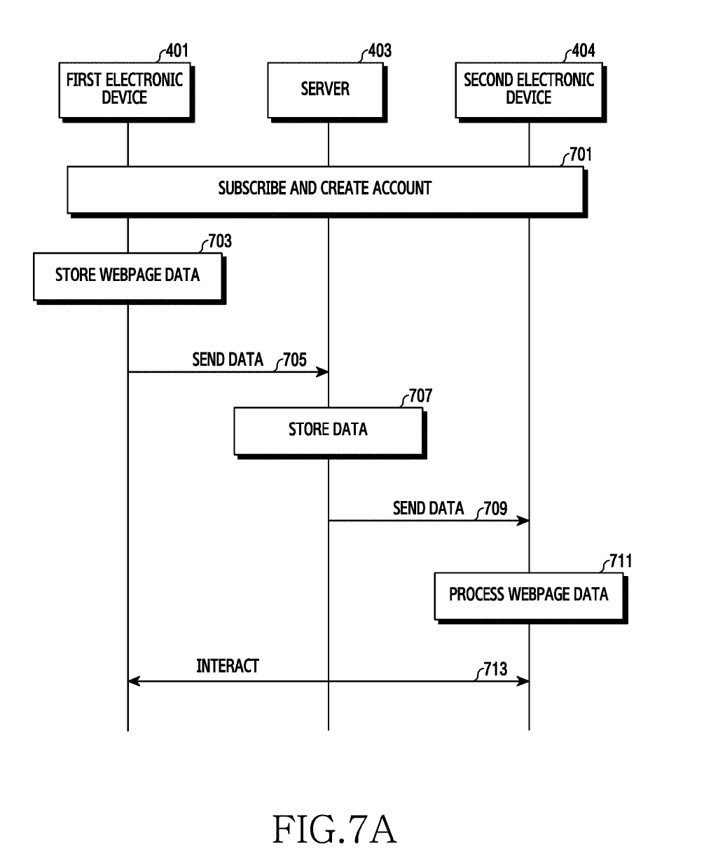

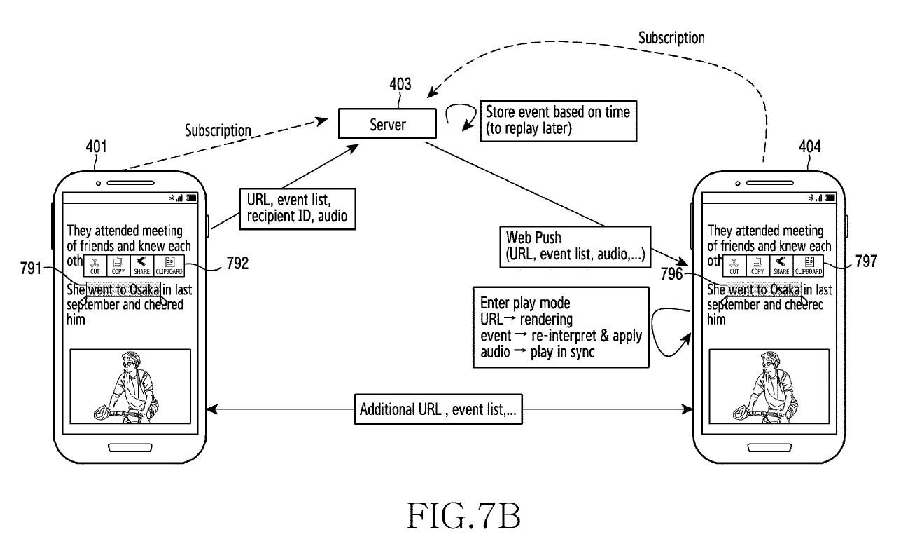

FIG. 7A illustrates operations for sharing a webpage via a server (e.g., the server 403 of FIG. 4) in real time according to various embodiments of the present disclosure. In FIG. 7A, a first electronic device (e.g., the first electronic device 401 of FIG. 4) shares a webpage in real time via the server 403, and a second electronic device (e.g., the second electronic device 404 of FIG. 4) processes data (e.g., an event at the first electronic device 401) of the webpage sharing received from the first electronic device 401. In various embodiments, the realtime screen sharing of FIG. 7A can be referred to as webpage sharing. The webpage sharing (or realtime sharing) can imply that substantially the same screen as a webpage screen which is output through an application (e.g., a web browser) of the first electronic device 401 is output from an application of the second electronic device 404 substantially at the same time. The webpage sharing can include displaying data of the webpage sharing of the first electronic device 401 in the second electronic device 404 with a certain time delay caused by a network environment and a data processing time of the first electronic device 401 or the second electronic device 404.

Referring to FIG. 7A, in operation 701, the first electronic device 401 and the second electronic device 404 can subscribe to a service provided by the server 403, and the server 403 can create accounts. The first electronic device 401 can directly receive information (e.g., an Identifier (ID)) of the second electronic device 404, or obtain information of the second electronic device 404 using profile information (e.g., a name, a phone number, an e-mail address of a recipient) from the database of the server 403.

In operation 703, the first electronic device 401 can generate data for sharing a webpage. The first electronic device 401 can generate and store the data including webpage generation information. According to an embodiment, before sharing the webpage, the first electronic device 401 can establish a connection to the server 403 and perform sharing configuration.

When the first electronic device 401 and the server 403 are connected and the sharing configuration is completed, the first electronic device 401 can send at least one URL and one or more recipient ID to the server 403 in operation 705. For example, the at least one URL can include at least one of a webpage URL, a URL of the webpage sharing data, and an address to access for the webpage sharing. According to an embodiment, the first electronic device 401 can transmit the data for the webpage sharing based on time, to the server 403. According to an embodiment, the first electronic device 401 can detect an event on the webpage in real time, generate data including event information of the webpage, and send the generated data to the server 403. For example, the first electronic device 401 can transmit data for displaying a drag 791 on a webpage text and editing tools 792 based on the drag, to the server 403. Also, the first electronic device 401 can transmit audio or video data relating to the event on the webpage, to the server 403.

In operation 707, the server 403 can store the webpage sharing data (e.g., the webpage URL, events on the corresponding webpage, or time information of the event) received from the first electronic device 401. The server 403 can also store the received audio and video data.

In operation 709, the server 403 can transmit the webpage sharing data of the first electronic device 401 to the second electronic device 404. According to an embodiment, the server 403 can transmit the webpage sharing data using web push. According to another embodiment, the server 403 can transmit the data including the URL added with hashcodes. According to an embodiment, the server 403 can transmit the data received from the first electronic device 401 to the second electronic device 404 in real time. The server 403 can store the data received from the first electronic device 401. The server 403 can transmit at least part of the received data to the second electronic device 404. While the event of the webpage is stored and then the webpage event sharing data is transmitted to the second electronic device 404 in FIG. 7A, the event of the webpage can stored and the webpage event sharing data can be transmitted at the same time as the event occurrence.

In operation 711, the second electronic device 404 can display the webpage based on the received webpage sharing data. The second electronic device 404 can render the webpage through an application using the received URL information. The second electronic device 404 can re-interpret the event on the webpage and apply the corresponding event to the webpage displayed through the application by processing the received webpage sharing data. The second electronic device 404 can synchronize and display the audio data received together with the webpage event information, with other event. For example, as shown in FIG. 7B, the second electronic device 404 can display a drag 796 on a webpage text and editing tools 797 based on the drag, on the webpage using the application.

In operation 713, the first electronic device 401 and the second electronic device 404 can exchange additional URL or event information. For example, the additional information can be exchanged via the server 403 or directly. The second electronic device 404 can input a text or a note to the received webpage. Data of the event generated by the second electronic device 404 can be forwarded to the first electronic device 401. The first electronic device 401 can process the received event data. Hence, the first electronic device 401 can interact with the second electronic device 404. The interaction of the first electronic device 401 and the second electronic device 404 in operation 713 is supplementary and can be omitted. According to an embodiment, operations 703 through 711 can be repeated.

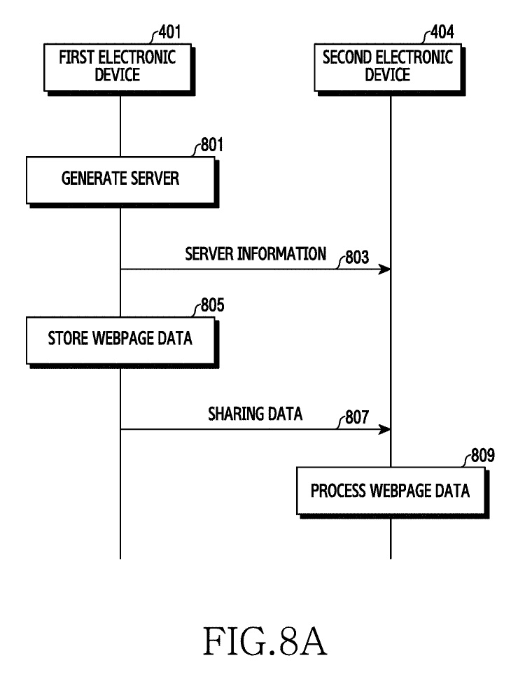

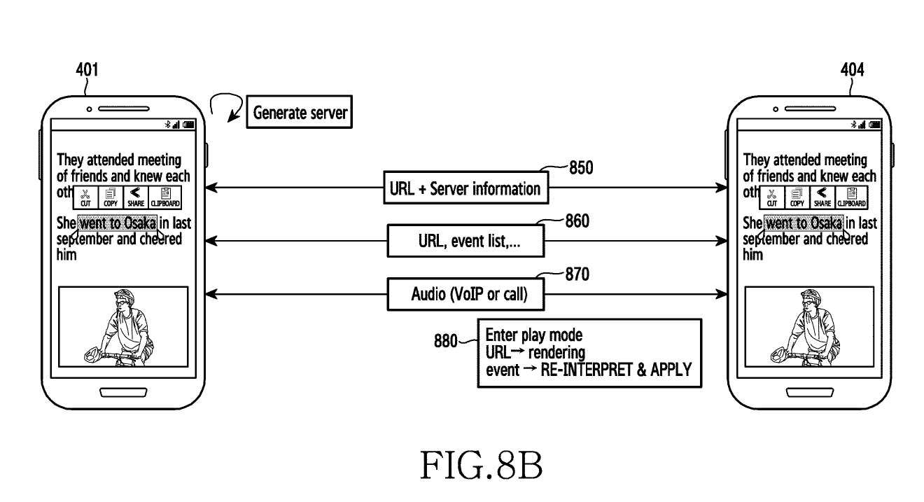

FIG. 8A illustrates operations for webpage sharing using an owned server according to various embodiments of the present disclosure. In FIG. 8A, an electronic device shares a webpage with another electronic device and concurrently serves as a server. For example, the electronic device can be the first electronic device 401 of FIG. 4 or the second electronic device 404 of FIG. 4.

Referring to FIG. 8A, in operation 801, a first electronic device (e.g., the first electronic device 401 of FIG. 4) can function as the server for the webpage sharing to a second electronic device (e.g., the second electronic device 404 of FIG. 4). For example, the first electronic device 401 can operate as the server by executing a program for operating as the server and setting server functions.

In operation 803, the first electronic device 401 can transmit server information, or data including URLs of webpages to share, to the second electronic device 404. For example, as shown in FIG. 8B, the server information can include a server ID and information 850 for accessing the server. The URL of the webpage can include, for example, information used to obtain a resource for generating the webpage.

In operation 805, the first electronic device 401 can store data (e.g., a touch event, audio, etc.) for the webpage sharing. For example, the first electronic device 401 can store an event relating to a webpage which is output through an application (e.g., a web browser), and generate data including event information.

In operation 807, the first electronic device 401 can send the webpage sharing data to the second electronic device 404. For example, the data 860 including the webpage URL and the event data on the webpage can be transmitted from the first electronic device 401 to the second electronic device 404. Referring to FIG. 8B, the first electronic device 401 and the second electronic device 404 can perform realtime voice communication using a Voice over Internet Protocol (VoIP) or call connection 870 and share the webpage. While the webpage sharing data is stored and then transmitted to the second electronic device 404 in FIG. 8A, the webpage sharing data can be stored and transmitted at the same time as the event occurrence.

In operation 809, the second electronic device 404 can process the webpage sharing data of the first electronic device 401 based on the data received from the first electronic device 401. For example, as shown in FIG. 8B, the second electronic device 404 can render the webpage through an application using the webpage URL information, and re-interpret and apply the event on the webpage based on the event information of the webpage in operation 880.

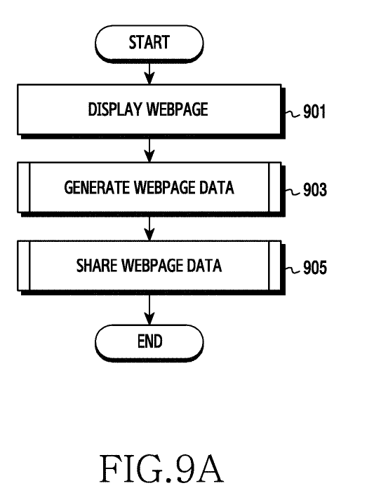

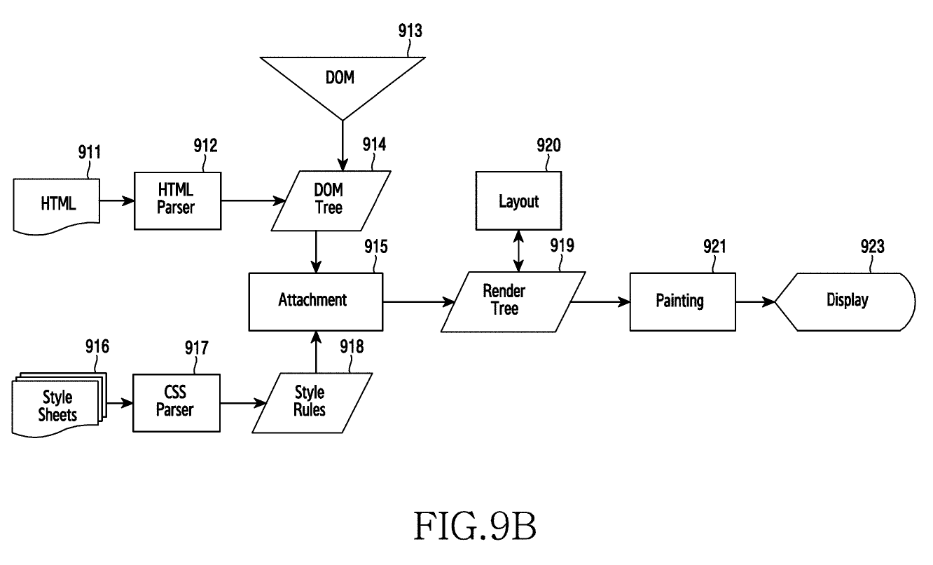

FIG. 9A illustrates a flowchart of a webpage sharing method in an electronic device according to various embodiments of the present disclosure. For example, the electronic device can be the first electronic device 401 of FIG. 4 or the second electronic device 404 of FIG. 4.

Referring to FIG. 9, in operation 901, a first electronic device (e.g., the first electronic device 401 of FIG. 4) can display a webpage. The webpage can be displayed through an application (e.g., a web browser) and include one or more objects. For example, the webpage can include contents including one or more of text, image, and video. Referring to FIG. 9B, the first electronic device 401 can obtain data for rendering the webpage using a URL. For example, the first electronic device 401 can obtain an html element 911 or style sheets 916. The first electronic device 401 can parse webpage objects in a DOM data structure (or a DOM tree). For example, the first electronic device 401 can parse the html element 911 in a DOM tree 914 using an html parser 912. The first electronic device 401 can parse the style sheets 916 with style rules 918 using a css parser 917. The first electronic device 401 can lay out the objects based on the DOM data structure, and paint the objects according to the layout. For example, the first electronic device 401 can generate a render tree 919 using attachment 915 of the DOM tree 914 and the style rules 918. The first electronic device 401 can display the webpage through layout 920 and painting 921 from the render tree 919. The webpage can be displayed by adjusting its size or arrangement according to a User Agent (UA) of the first electronic device 401.

In operation 903, the first electronic device 401 can generate data to store for the webpage sharing. The data to store for the webpage sharing can include information for processing the event of the webpage of the application processed in the first electronic device 401, through an application of a second electronic device (e.g., the second electronic device 404 of FIG. 4).

In operation 905, the first electronic device 401 can send the generated data stored for the webpage sharing to the second electronic device 404. The first electronic device 401 can provide its generated data to the second electronic device 404. The first electronic device 401 can send or receive a signal for interacting with the second electronic device 404 in relation to the sharing webpage. The interaction of the first electronic device 401 and the second electronic device 404 is supplementary and accordingly can be omitted.

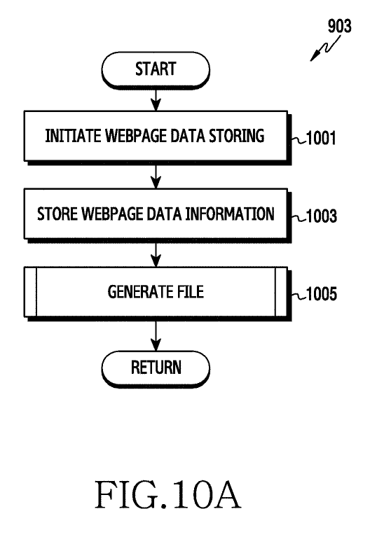

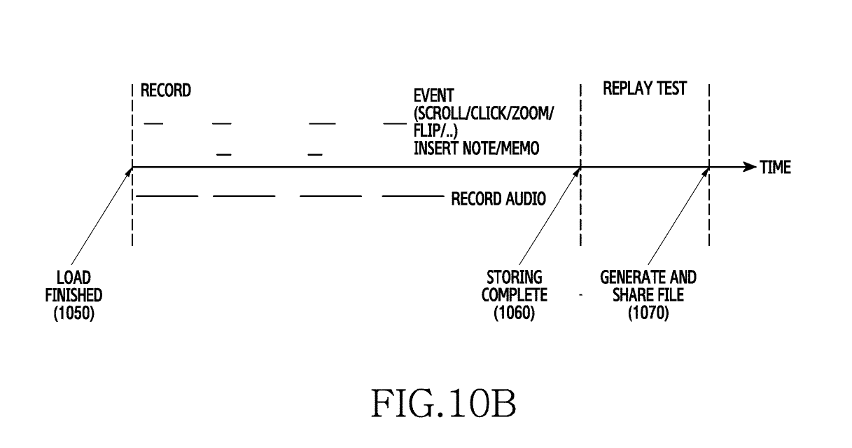

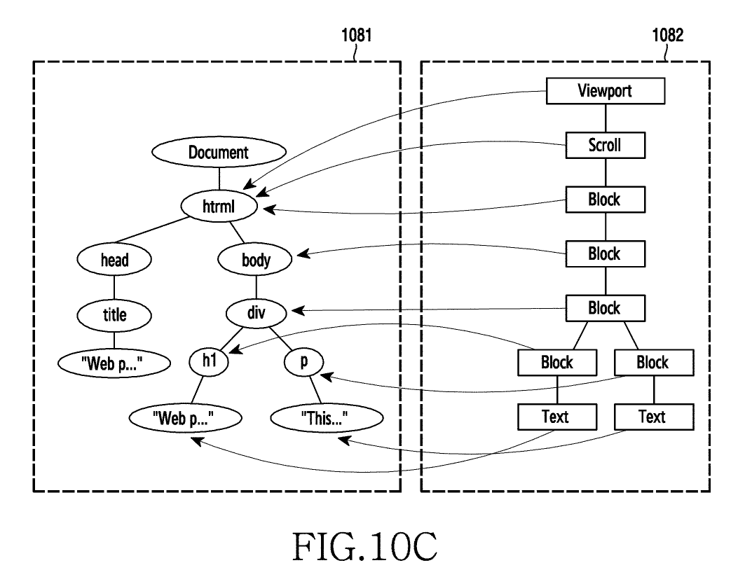

FIG. 10A illustrates a flowchart of a method for generating data for webpage sharing in a first electronic device according to various embodiments of the present disclosure. For example, the electronic device can be the first electronic device 401 or the second electronic device 404 of FIG. 4.

Referring to FIG. 10A, in operation 1001, a first electronic device (e.g., the first electronic device 401 of FIG. 4) can store data for webpage sharing. The first electronic device 401 can store an event on the webpage in response to a user input for the webpage sharing. When a predefined condition (e.g., webpage loading complete) is satisfied, the first electronic device 401 can store the event on the webpage. For example, referring to FIG. 10B, the first electronic device 401 can confirm loading of information for displaying the webpage. For example, the first electronic device 401 can receive information about a webpage to receive from a web server, and confirm the loading of information for webpage parsing, layout, and painting based on the received information. According to an embodiment, when at least part of the webpage information is loaded and when or after the first electronic device 401 displays at least part of the webpage using at least part of the loaded webpage information in operation 1050, the first electronic device 401 can store the event of the webpage.

In operation 1003, the first electronic device 401 can store the data for the webpage sharing. The stored event of the webpage can include an event processed in the webpage according to an input such as scroll, click, or zoom. Also, the first electronic device 401 can store an event such as memo insertion or audio recording on the webpage after the storing commences. For example, referring to FIG. 10B, the event on the webpage after storing the webpage event commences can be stored in association with the time of the corresponding event. For example, the event conducted by the first electronic device 401 on the displayed webpage can be stored on the time basis. The webpage time information can include at least one of an absolute time of the corresponding event, a time elapsed from the start of storing the webpage event, and a time elapsed from a previous event. For example, the event on the webpage can be matched and stored with its time as shown in Table 1.

TABLE 1

| | |
|---|---|
| Time | Event |

| | | |
|---|---|---|
| 00:00:01.00 | 00:00:20.00 | Scroll(100, 200) |
| 00:00:30.00 | 00:00:40.00 | Zoom(25, 36, 150%) |
| 00:00:40.00 | 00:00:45.00 | Add(“ppath1”) |

According to an embodiment, coordinates in the event list are not coordinates on the screen and can correspond to coordinates based on a page or relative coordinates based on a current DOM node which corresponds to various resolutions of a recipient. Information about the DOM node of an object of a current event can be obtained from left DM nodes 1081 of the current event of FIG. 10C or from a combination of screen region information of the event and render tree information 1082 having node arrangement information of FIG. 10C. The DOM tree and the render tree of FIG. 10C are general names of a web engine field, which are not further described, and can be referred to a content model or a frame tree respectively according to a web engine.

According to an embodiment, the first electronic device 401 can associate and store an event type, event object information (e.g., object coordinates), or an event time in the list for storing the event on the webpage as shown in Table 1. In the list for storing the event, the object coordinates can include not only the coordinates on the screen but also the coordinates based on the page or the relative coordinates based on the DOM node of the object of the event. When storing the DOM node coordinates of the object, the webpage can be displayed according to various resolutions of the second electronic device 404.

According to various embodiments of the present disclosure, the event time can store a start time and an end time of the event as shown in Table 1. The time information can allow the second electronic device 404 to process the event with an adequate animation based on the corresponding time. For example, when the user scrolls between one second and 20 seconds, the scroll start time at one second and the scroll end time at 20 seconds can be stored. The event time can be stored continuously so that the corresponding event is processed alike during the actual event time. For example, when an event occurs, webpage event data processed per event time unit (e.g., 10 ms) can be stored. For example, when the user scrolls between one second to 20 seconds, the first electronic device 401 can store a scrolled webpage point per unit time (e.g., 10 ms).

According to various embodiments of the present disclosure, the event can be stored with the start time and the end time. When the event is stored together with recording or storing, the event can be continuously stored to match the display screen of the first electronic device 401 and synchronized with audio or images. How to store the event can be determined based on a communication environment between the first electronic device 401 and the second electronic device 404. For example, when the communication environment is relatively good (e.g., when remaining data capacity is sufficient, when a radio channel condition is good), the event is continuously stored. In a poor communication environment, only the start time and the end time of the event can be stored. When an application type (e.g., web browser type) of the first electronic device 401 and the second electronic device 404 is different and content is incompatible, an event of a corresponding content can be stored continuously. For example, when a video format which can be output from the application of the first electronic device 401 is not output from the second electronic device 404, a corresponding video can be stored as an animation.

In operation 1005, the first electronic device 401 can generate a file including the webpage sharing data based on the event information of the webpage. For example, the generated file can include data (e.g., URL, html element) for generating the webpage and the event data stored in operation 1003.

Referring to FIG. 10B, before generating the file after the storing finished 1060, the first electronic device 401 can conduct a test for processing the stored events based on the time. For example, the first electronic device 401 can test whether the stored events are normally matched based on the time or whether the stored event and the recorded audio are synchronized in the webpage. When the display test 1070 is completed, the first electronic device 401 can generate the file to provide to the second electronic device 404 based on the event information of the webpage. According to an embodiment, the first electronic device 401 may skip the test for processing the stored events based on the time.

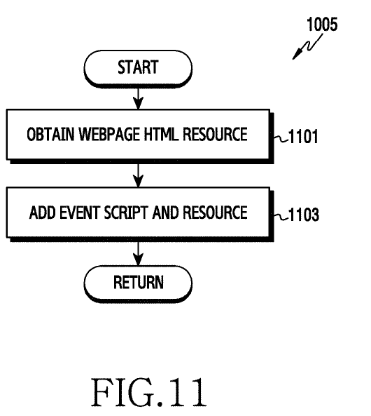

FIG. 11 illustrates a flowchart of a method for generating a file including data for webpage sharing in an electronic device according to various embodiments of the present disclosure. The electronic device can be the first electronic device 401 or the second electronic device 404 of FIG. 4.

In operation 1101, a first electronic device (e.g., the first electronic device 401 of FIG. 4) can confirm a resource for generating a webpage. The resource for generating the webpage can include an html element, a script, a css, image data, and sound data of the webpage.

In operation 1103, the first electronic device 401 can add data about an event of a corresponding webpage. The added data can include, for the webpage sharing, event data on the corresponding webpage. For example, the event data on the webpage can include an html element, a script, scalable vector graphics (svg), or sound data of the event stored by the first electronic device 401. Using the resource for generating the webpage and the event data of the webpage, a second electronic device (e.g., the second electronic device 404 of FIG. 4) can process events and audio designated with the webpage based on time.

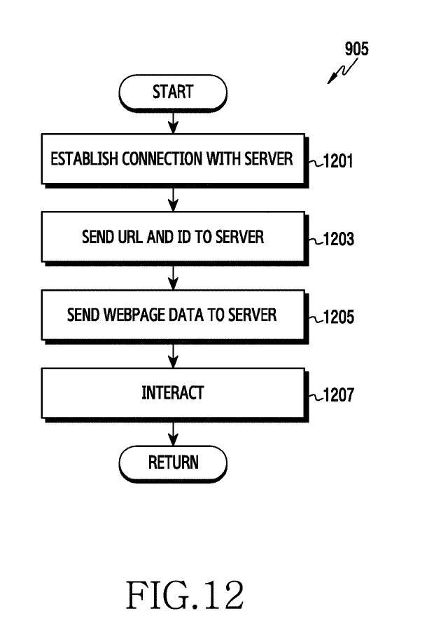

FIG. 12 illustrates a flowchart of a method for providing data for webpage sharing to another electronic device via an external server in an electronic device according to various embodiments of the present disclosure. The electronic device or the other electronic device can be, for example, the first electronic device 401 or the second electronic device 404 of FIG. 4.

In operation 1201, a first electronic device (e.g., the first electronic device 401 of FIG. 4) can establish a connection with a server (e.g., the server 403 of FIG. 4). For example, the first electronic device 401 can subscribe to a service provided from the server 403. The first electronic device 401 can have connection information (e.g., ID, phone number, Media Access Control (MAC) address) for the server 403. The first electronic device 401 can establish the connection with the server 403 using such information.

In operation 1203, the first electronic device 401 can send to the server 403, a URL for the webpage sharing and information (e.g., ID, phone number, MAC address) of the second electronic device 404. For example, the URL can be used to obtain a webpage resource. The URL can be set by the first electronic device 401. According to another embodiment, the URL can be set by the server 403. The first electronic device 401 can directly receive the information of the second electronic device 404, or obtain the information of the second electronic device 404 using profile information (e.g., name, phone number, e-mail address of a recipient) from a database of the server 403.

In operation 1205, the first electronic device 401 can transmit data for the webpage sharing to the server 403. For example, the data for the webpage sharing can include a resource for generating the webpage and event data of the webpage. The data for the webpage sharing can be transmitted as a file of an adequate format for the sake of the webpage sharing.

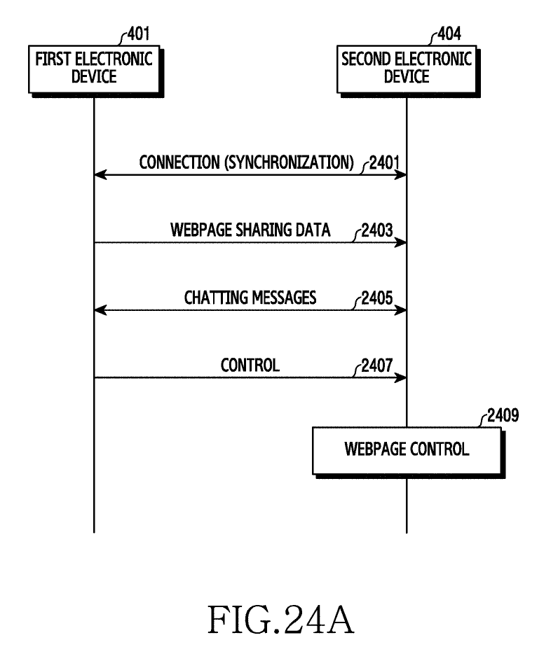

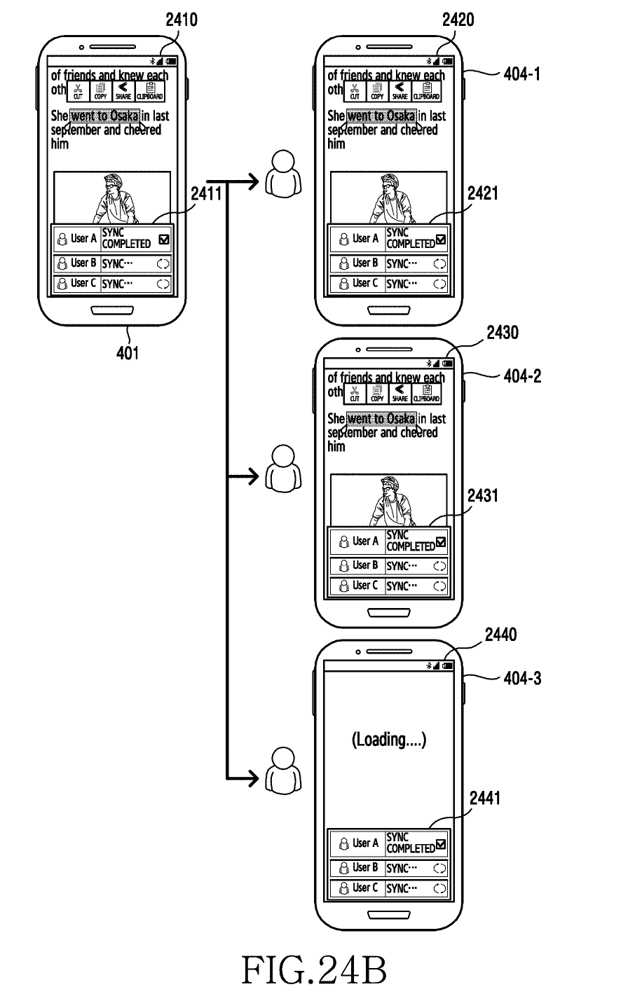

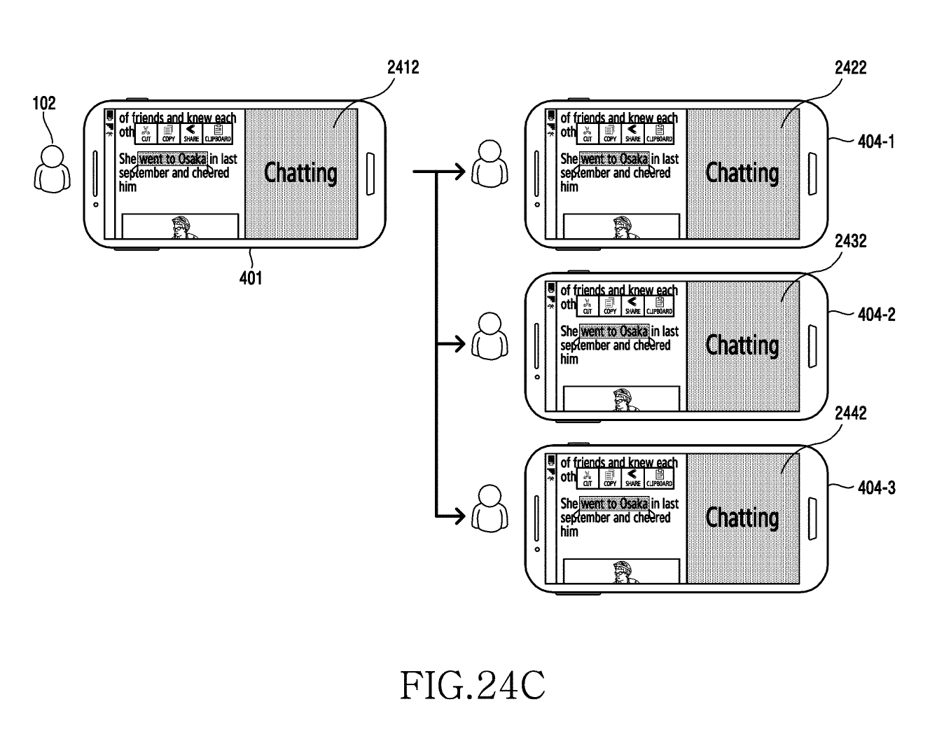

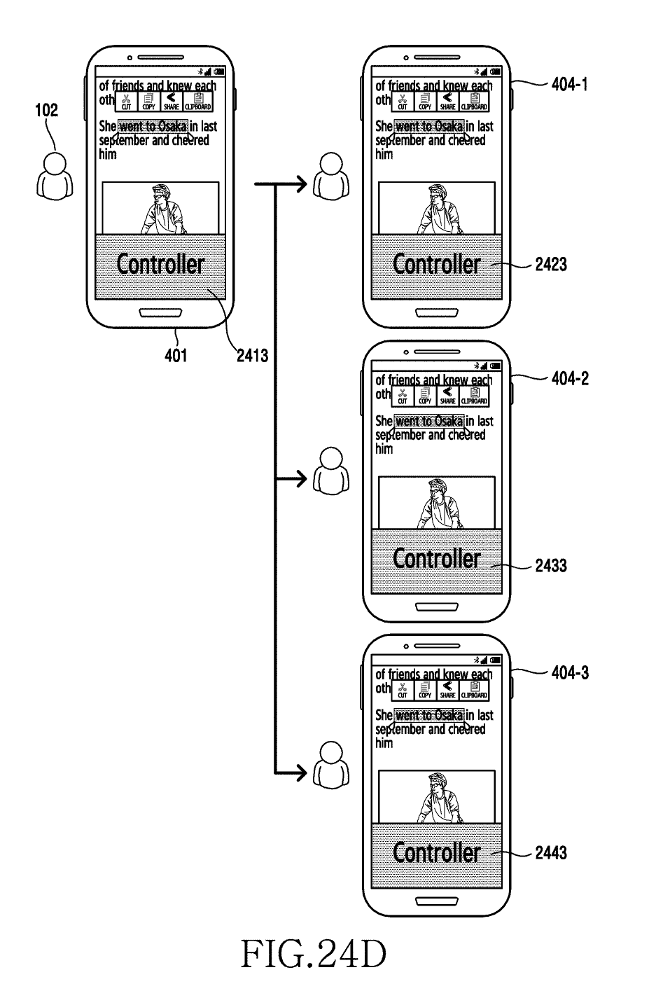

In operation 1207, the first electronic device 401 can send or receive a signal for interacting with the second electronic device (e.g., the second electronic device 404 of FIG. 4). The first electronic device 401 can share the webpage and concurrently give webpage control to the second electronic device 404 as shown in FIG. 24D. The first electronic device 401 can share the webpage and concurrently perform chatting or voice communication with the second electronic device 404 as shown in FIG. 24C. The interaction of the first electronic device 401 and the second electronic device 404 in operation 1207 can be omitted. For example, only the first electronic device 401 can send an event relating to the webpage sharing to the second electronic device 404.

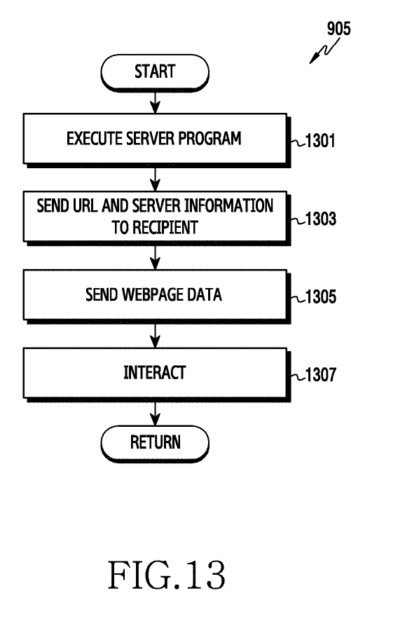

FIG. 13 illustrates a flowchart of a method for providing data for webpage sharing to another electronic device via an owned server in an electronic device according to various embodiments of the present disclosure. The electronic device or the other electronic device can be, for example, the first electronic device 401 or the second electronic device 404 of FIG. 4.

In operation 1301, a first electronic device (e.g., the first electronic device 401 of FIG. 4) can execute a server program. The processor 520 can execute the program for operating as a server and operate as the server by setting server functions. The first electronic device 401 can temporarily function as the server. When the webpage sharing is finished, the first electronic device 401 can end the server program.

In operation 1303, the first electronic device 401 can send a URL for the webpage sharing and server information generated using the server program, to a second electronic device (e.g., the second electronic device 404 of FIG. 4). For example, the URL for the webpage sharing can include a resource for generating the webpage and an address for obtaining or processing data of an event on the webpage. The second electronic device 404 can access the URL for the webpage sharing and thus download the webpage resource and the event data of the webpage of the first electronic device 401. Also, the second electronic device 404 can process the event of the webpage of the first electronic device 401, in a webpage corresponding to the webpage sharing URL. The server information can include, for example, a server ID and information for accessing the server.

In operation 1305, the first electronic device 401 can transmit the data for the webpage sharing to the second electronic device 404. The data for the webpage sharing can include the resource for generating the webpage or the event information of the webpage. According to an embodiment, the webpage sharing data can be transmitted as a file of an adequate format for the webpage sharing. According to various embodiments of the present disclosure, the first electronic device 401 can transmit the webpage sharing data to the second electronic device 404 using a short-range communication method such as D2D or Wi-Fi direct.

In operation 1307, the first electronic device 401 can send or receive a signal for interacting with the second electronic device 404 with respect to the webpage. The first electronic device 401 can share the webpage and give webpage control to the second electronic device 404 as shown in FIG. 24D. The first electronic device 401 can share the webpage and concurrently perform chatting or voice communication with the second electronic device 404 as shown in FIG. 24C. The interaction of the first electronic device 401 and the second electronic device 404 in operation 1307 is supplementary and can be omitted.

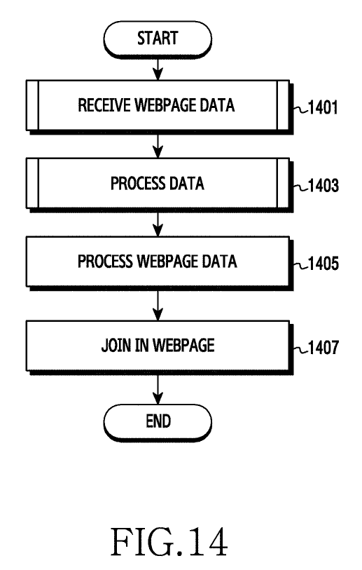

FIG. 14 illustrates a flowchart of a method for processing a webpage event of another electronic device in an electronic device according to various embodiments of the present disclosure. The electronic device can be the first electronic device 401 or the second electronic device 404 of FIG. 4.

In operation 1401, a second electronic device (e.g., the second electronic device 404 of FIG. 4) can receive data for webpage sharing. The data for the webpage sharing can include a resource for generating a webpage and event data on the webpage. For example, the webpage sharing data can include the event on the webpage, or event contents (e.g., memo, audio data). The webpage sharing data can be an mhtml file including an html element, script, svg, or sound data. The second electronic device 404 can receive the webpage sharing data from the external server 430, or directly from the first electronic device 401 using a server program of the first electronic device 401.

In operation 1403, the second electronic device 404 can process the data to process the received webpage sharing data. The second electronic device 404 can analyze the data received from the first electronic device 401, and obtain the resource for generating the webpage and the event on the webpage from the received data.

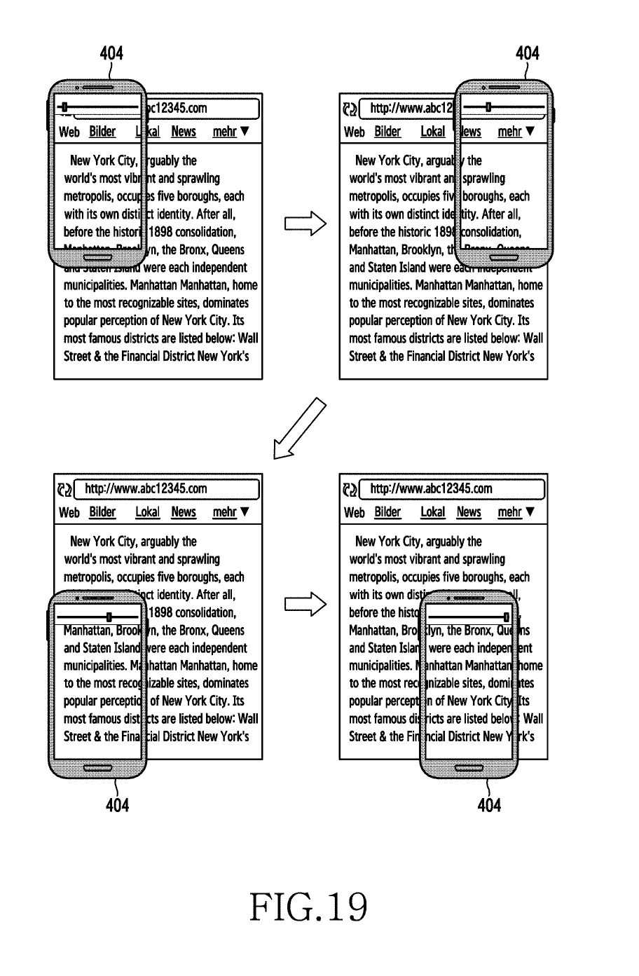

In operation 1405, the second electronic device 404 can process the data to display the webpage. The second electronic device 404 can render a webpage using an application (e.g., a web browser) to display the event on the webpage. Based on time information of the webpage event data, the second electronic device 404 can process the event on the webpage based on time. The second electronic device 404 can process the event of the shared webpage in real time according to its browser. For example, the second electronic device 404 can process the event which scrolls the webpage based on time. Referring to FIG. 19, the second electronic device 404 can initially display an upper left portion of a webpage and then display an upper right portion, a left lower portion, and a right lower portion of the webpage through scroll events.

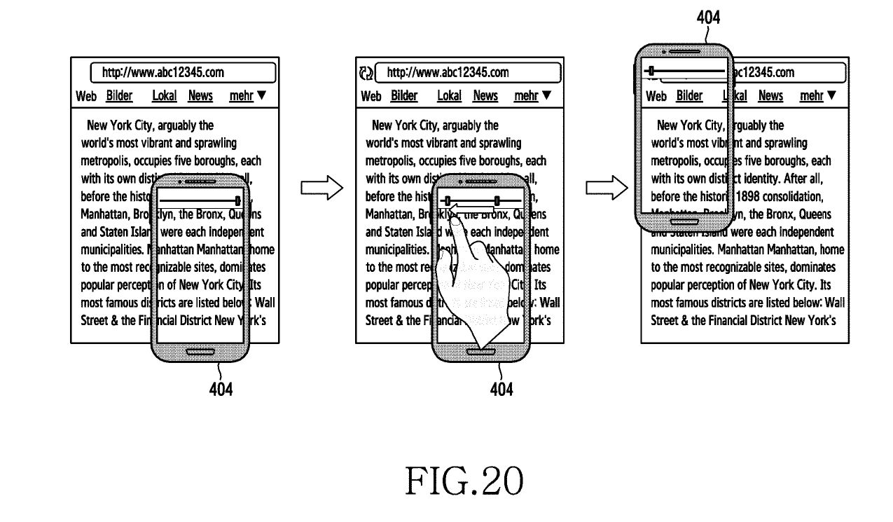

According to an embodiment, the second electronic device 404 can adjust the time for processing the webpage event and process the event corresponding to the adjusted time. Referring to FIG. 20, the second electronic device 404 can display a right lower portion of a webpage based on time, and, when a user input drags the time to an initial point, displays an upper left portion of the webpage at the initial point which is a previous screen before a scroll event.

In operation 1407, the second electronic device 404 can join in the webpage and interact with the first electronic device 401. The second electronic device 404 can send or receive a signal for interacting with the first electronic device 401. The second electronic device 404 can process the webpage event in real time and obtain the webpage control from the first electronic device 401. The second electronic device 404 can process the webpage event in real time and concurrently perform chatting or voice communication with the first electronic device 401 as shown in FIG. 24C. The interaction of the first electronic device 401 and the second electronic device 404 in operation 1407 is supplementary and can be omitted.

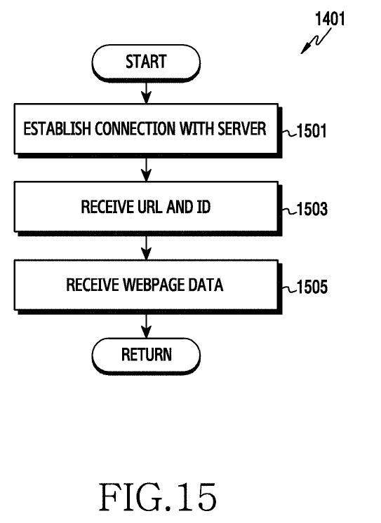

FIG. 15 illustrates a flowchart of a method for receiving data for webpage sharing of another electronic device via an external server in an electronic device according to various embodiments of the present disclosure. The electronic device can be the first electronic device 401 or the second electronic device 404 of FIG. 4.

In operation 1501, a second electronic device (e.g., the second electronic device 404 of FIG. 4) can establish a connection with the server 403. According to an embodiment, the second electronic device 404 can be subscribed to a server provided from a server (e.g., the server 403 of FIG. 4) and obtain information for accessing the server 403. For example, the second electronic device 404 can establish the connection with the server 403 to share a webpage in real time using a corresponding account ID.

In operation 1503, the second electronic device 404 can receive a URL and information (e.g., ID) of the first electronic device 401. For example, the URL can be used to obtain a resource of the webpage. According to an embodiment, a sharing URL can be set by the server 403. The second electronic device 404 can identify the first electronic device 401 using the information of the first electronic device (e.g., the first electronic device 401 of FIG. 4), and use the webpage sharing data and the information of the first electronic device 401 in additional data exchange.

In operation 1505, the second electronic device 404 can receive the data for the webpage sharing from the server 403. For example, the webpage sharing data can include a resource for generating the webpage, event data on the webpage of the first electronic device 401, and data for processing the event on the webpage. For example, the webpage sharing data can be a file of an adequate format for the webpage sharing, and include an mhtml file including an html element and media data. The second electronic device 404 can download the resource for generating the webpage from the first electronic device 401 via the server 430.

By downloading the resource for generating the webpage from the first electronic device 401 instead of an original webpage location (e.g., a web server which provides the webpage), the second electronic device 404 can avoid a problem caused when the web server which is the original location changes the resource, or a collision (e.g., cross site scripting) with another device in relation to the webpage. According to another embodiment of the present disclosure, the second electronic device 404 can download the resource for sharing the webpage from the original webpage location (e.g., the web server which provides the webpage).

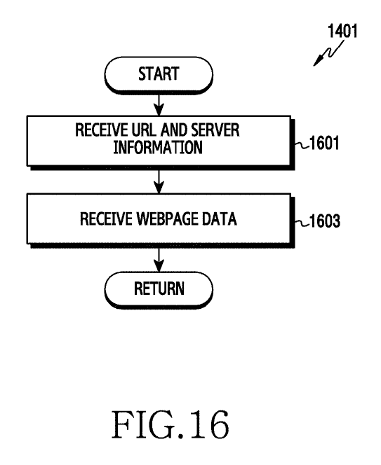

FIG. 16 illustrates a flowchart of a method for receiving data for webpage sharing of another electronic device via an owned server of the other electronic device in an electronic device according to various embodiments of the present disclosure. The electronic device can be, for example, the first electronic device 401 or the second electronic device 404 of FIG. 4.

In operation 1601, a second electronic device (e.g., the second electronic device 404 of FIG. 4) can receive a sharing URL and owned server information of a first electronic device (e.g., the first electronic device 401 of FIG. 4). The server information can include a server ID generated by the first electronic device 401 and information for accessing the server.

In operation 1603, the second electronic device 404 can receive data for webpage sharing. For example, the data for the webpage sharing can include a resource for generating the webpage, event data on the webpage of the first electronic device 401, and data for processing the event on the webpage. For example, the webpage sharing data can be a file of an adequate format for the webpage sharing, and include an mhtml file including an html element and media data. The second electronic device 404 can download the resource for generating the webpage directly from the first electronic device 401, or from an original resource location of the webpage.

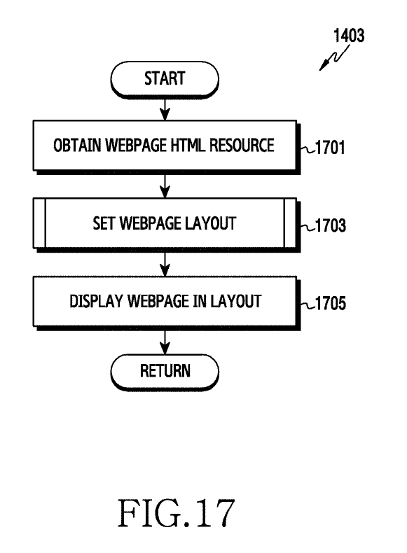

FIG. 17 illustrates a flowchart of a method for processing webpage sharing data of another electronic device in an electronic device according to various embodiments of the present disclosure. For example, the electronic device can be, for example, the first electronic device 401 or the second electronic device 404 of FIG. 4.

In operation 1701, a second electronic device (e.g., the second electronic device 404 of FIG. 4) can obtain a resource for generating a webpage from webpage sharing data received. For example, the resource for generating the webpage can include an html element, script, css, image data, and sound data of the webpage. The second electronic device 404 can obtain objects to display in the webpage from the webpage resource using an application (e.g., a web browser). The second electronic device 404 can obtain DOM node coordinates of the webpage objects.

In operation 1703, the second electronic device 404 can set a layout for processing an event of a webpage. The second electronic device 404 can obtain webpage rendering information from the webpage resource, parse objects of the webpage in a DOM data structure, and lay out the objects based on the DOM data structure using the application. The second electronic device 404 can obtain an event to process at each time from the event data of the webpage. The second electronic device 404 can set the webpage layout using corresponding event data. For example, when an event underlines a text on the webpage, the second electronic device 404 can set the layout to underline a corresponding text with an animation with respect to a start point and an end point of the underlining event.

The processor 520 of the second electronic device 404 can set the layout to display the webpage in accordance with a resolution of the second electronic device 404. The layout for displaying the webpage can be dynamically configured based on a width of a viewport. The processor 520 of the second electronic device 404 can set the resolution and display the webpage in the set resolution. The processor 520 of the second electronic device 404 can display the webpage by dynamically setting various resolutions.

In operation 1705, the second electronic device 404 can process the event on the webpage according to the layout. The second electronic device 404 can process a corresponding event on the webpage based on time by referring to the webpage data. For example, the second electronic device 404 can display a webpage in the display 530 in accordance with a scroll event of the webpage as shown in FIG. 19 and FIG. 20.

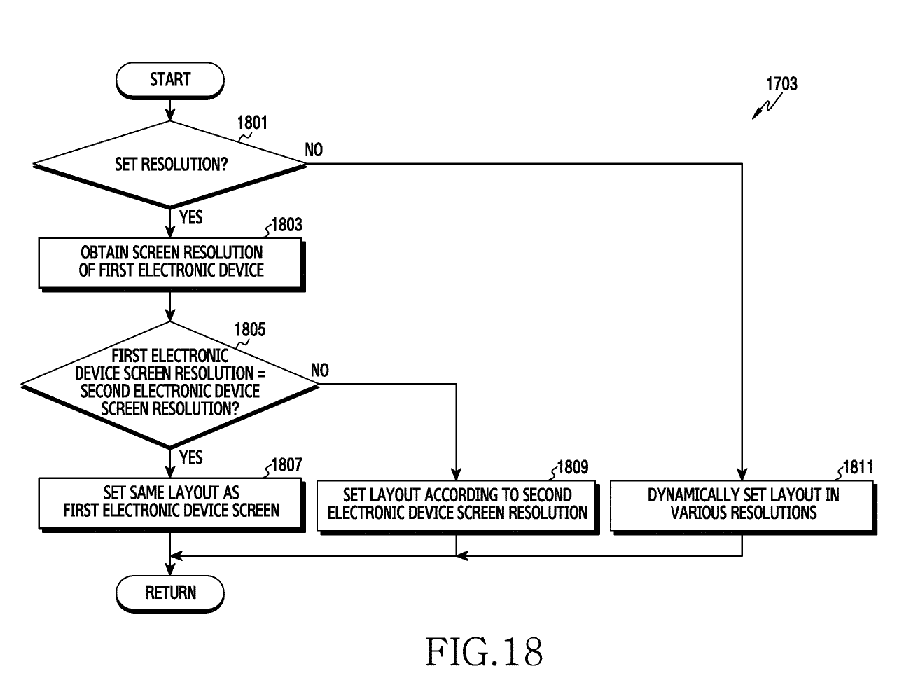

FIG. 18 illustrates a flowchart of a method for setting a layout of a webpage shared in an electronic device according to various embodiments of the present disclosure. The electronic device can be, for example, the first electronic device 401 or the second electronic device 404 of FIG. 4.

In operation 1801, the processor 520 of a second electronic device (e.g., the second electronic device 404 of FIG. 4) can determine whether a resolution for displaying the sharing webpage is set. For example, the resolution for displaying the webpage can be set by an application (e.g., a web browser) or a user input. The resolution for displaying the webpage can be dynamically set according to a webpage configuration.

When the resolution for displaying the sharing webpage is set in operation 1801, the second electronic device 404 can obtain a screen resolution of a first electronic device (e.g., the first electronic device 401 of FIG. 4) in operation 1803. The second electronic device 404 can obtain screen resolution information of the first electronic device 401 from webpage sharing data received from the first electronic device 401. According to another embodiment, the second electronic device 404 can obtain the screen resolution of the first electronic device 401 from information about the first electronic device 401 registered in the server 403.

In operation 1805, the second electronic device 404 can determine whether the screen resolution of the first electronic device 401 matches its screen resolution. The screen resolution match can include the same resolution and a certain range (e.g., 5%) of the first electronic device 401 and the second electronic device 404. For example, when the first electronic device 401 and the second electronic device 404 are of the same type, their screen resolution can match.

When the screen resolution of the first electronic device 401 matches the screen resolution of the second electronic device 404, the second electronic device 404 can set the same layout as the screen resolution of the first electronic device 401 in operation 1807. Thus, the second electronic device 404 can display the same screen as the screen of the first electronic device 401.

When the screen resolution of the first electronic device 401 and the screen resolution of the second electronic device 404 are different, the processor 520 of the second electronic device 404 can set the layout for its screen resolution in operation 1809. The second electronic device 404 can set the layout to display webpage objects in accordance with its screen resolution. The second electronic device 404 can adjust a width of the webpage layout according to the difference of the screen resolution of the first electronic device 401 and the screen resolution of the second electronic device 404.

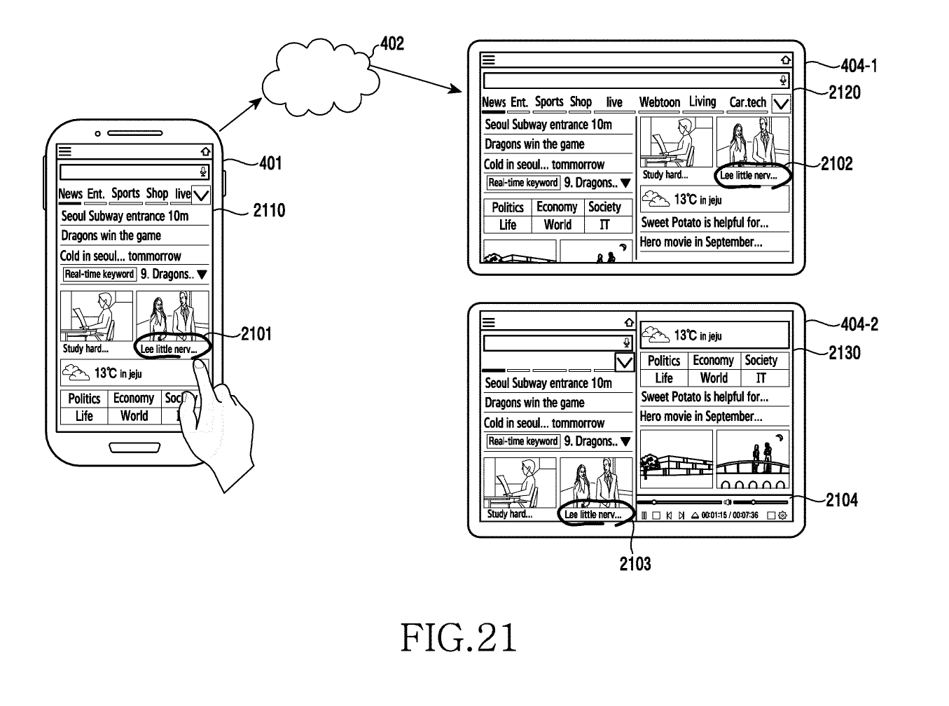

According to an embodiment, when a screen width of the second electronic device 404 is greater than a screen width of the first electronic device 401 over a certain value, the second electronic device 404 can set the layout to display the webpage in two or more columns. For example, as shown in FIG. 21, when displaying a main page of a portal site, the second electronic device 404 can lay out a first screen 2120 to display objects corresponding to a search bar and a main item of the portal site throughout the width and other objects in two columns. The second electronic device 404 can lay out a second screen 2130 to display all of the webpage objects in two columns.

According to an embodiment, by displaying the objects in two columns, the second electronic device 404 can set the layout to display more objects than the screen of the first electronic device 401. The second electronic device 404 can identify an event (e.g., add a pen input image 2201) on the webpage of the first electronic device 401, and add the same objects 2202 and 2203 as the event object 2201 on the webpage screen. As shown in FIG. 21, the second electronic device 404 can display not only the same object as the added object to the event on the webpage screen 2110 of the first electronic device 401 but also similar objects 2102 and 2103, as event to objects, to an object 2101 added in a second electronic device 404-1 or 404-2 on a webpage screen 2120 or 2130. The second electronic device 404 can display a control interface 2104 for the webpage display of FIG. 21. The control interface 2104 of the webpage display can include an object for controlling a webpage display time and an object for controlling a recorded sound volume.

When not setting the resolution in operation 1801, the second electronic device 404 can dynamically configure the webpage according to its screen resolution, rather than the screen of the first electronic device 401. The second electronic device 404 can reconfigure the webpage according to DOM node coordinates of the objects of the webpage and display the reconfigured webpage.

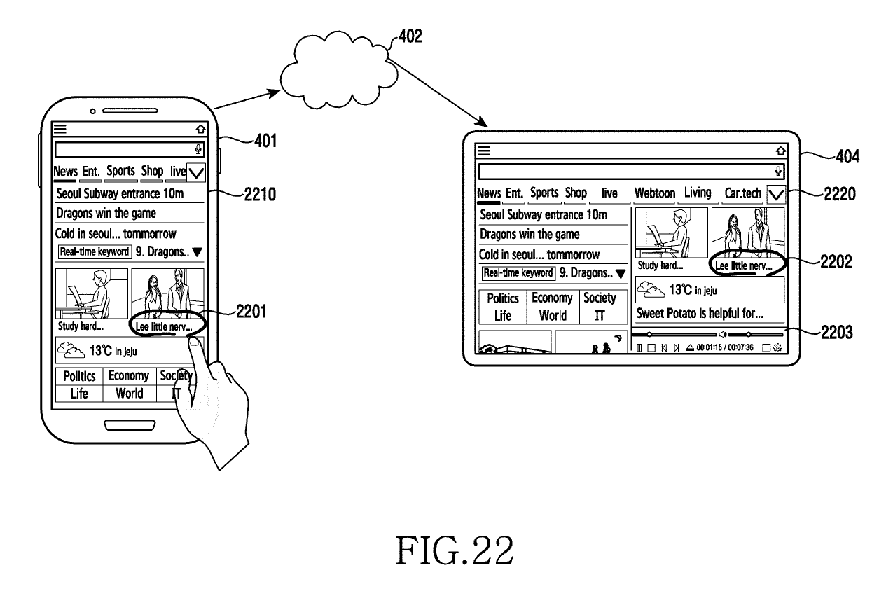

Referring to FIG. 22, the second electronic device (e.g., the second electronic device 404 of FIG. 4) can process an event of a webpage according to its resolution. When the first electronic device (e.g., the first electronic device 401 of FIG. 4) executes an event (e.g., add a pen input image 2201) on a webpage 2210, the second electronic device 404 can identify an object relating to a corresponding event, interpret the corresponding event according to a location of the corresponding object on its webpage screen 2220, and process the corresponding event according to the location of the corresponding object. In FIG. 22, to display an object in the same range as the screen 2210 of the first electronic device 401, the second electronic device 404 can display a control interface 2203 for controlling the event output on the webpage in a remaining space after all of objects of the screen 2210 of the first electronic device 401 are displayed. According to another embodiment, the second electronic device 404 can leave the remaining space empty after displaying all of the objects of the screen 2210 of the first electronic device 401, or display an advertisement.

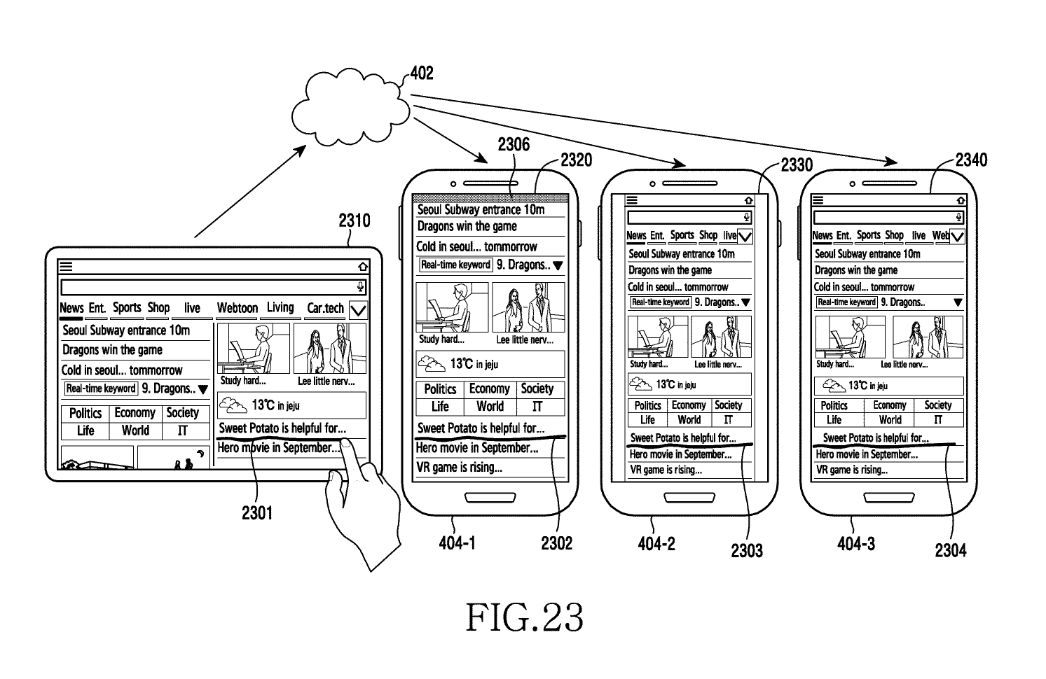

Referring to FIG. 23, when all of screens 2320, 2330, and 2340 of electronic devices 404-1, 404-2, and 404-3 cannot display a screen 2310 of a first electronic device (e.g., the first electronic device 401 of FIG. 4), the electronic devices 404-1, 404-2, and 404-3 can set a webpage layout in accordance with their screen resolution. The electronic devices 404-1, 404-2, and 404-3 can generate the webpage screen to first display an object 2301 relating to a current event on the screen 2310 of the first electronic device 401.

For example, the screen 2320 of the electronic device 404-1 can scroll to display an object 2302 of the current event, and display an object 2306 which is shaded to indicate more objects not displayed.

According to another embodiment, the screen 2330 of the electronic device 404-2 can zoom out a webpage to display all of objects of the screen 2310 of the first electronic device 401, and display an object 2303 of the current event.

According to yet another embodiment, the screen 2340 of the electronic device 404-3 can display a webpage to minimize whole screen distortion by partially changing most unrelated portion of the object 2304 of the current event of the first electronic device 401. Relations of the object 2304 of the current event and the objects can be determined by calculating distances between the object 2304 of the event and other objects based on the object 2304 of the current event and a DOM data structure of the other objects. According to other embodiments, the relations of the object 2304 of the current event and the objects can be determined based on distances between the event object 2304 and the other objects on the screen.

Now, an electronic device and one or more other electronic devices share a webpage and currently interact with each other in FIGS. 24A through 24D. The electronic device can be, for example, the first electronic device 401 or the second electronic device 404 of FIG. 4. The interaction of the electronic devices is supplementary and accordingly can be omitted.

FIG. 24A illustrates operations for interactions when a first electronic device (e.g., the first electronic device 401 of FIG. 4) and a second electronic device (e.g., the second electronic device 404 of FIG. 4) share a webpage screen according to various embodiments of the present disclosure. While only one second electronic device 404 is depicted in FIG. 24A to ease the understanding, a plurality of electronic devices 404-1, 404-2, and 404-3 can interact with the first electronic device 401 as shown in FIGS. 24B, 24C, and 24D.

Referring first to FIG. 24A, in operation 2401, the first electronic device 401 and the second electronic device 404 can establish a connection for webpage sharing. The first electronic device 401 and the second electronic device 404 can perform synchronization for the webpage sharing and obtain connection information and synchronization information. The synchronization can indicate that the first electronic device 401 and the second electronic devices 404-1, 404-2, and 404-3 display substantially the same webpage screen and provide the user with an interaction service such as voice chatting. According to an embodiment, the first electronic device 401 and the second electronic device 404 can display sharing state information. For example, referring to FIG. 24B, the first electronic device 401 and the second electronic devices 404-1, 404-2, and 404-3 can display an interface 2411, 2421, 2431, and 2441 indicating the synchronization with other devices. In FIG. 24B, the first electronic device 401 can share a webpage 2410, and the second electronic device 404-1 can complete the synchronization with the first electronic device 401, display its reconfigured webpage 2420 of the first electronic device 401, and concurrently interact with the first electronic device 401. The second electronic device 404-2 may complete the reconfiguration of the webpage 2430 of the first electronic device 401 but may not finish the synchronization of the interaction service. Also, the second electronic device 404-3 may not finish the webpage configuration.

According to various embodiments of the present disclosure, after synchronizing with the second electronic devices 404-1, 404-2, and 404-3, the first electronic device 401 can transmit data for sharing the webpage 2410 in order to share the 2410. In other embodiments of the present disclosure, the first electronic device 401 can send the data for sharing the webpage 2410, regardless of the synchronization with the second electronic devices 404-1, 404-2, and 404-3. A user of the first electronic device 401 can confirm the interface 2411 indicating the synchronization and wait until the synchronization with the second electronic devices 404-1, 404-2, and 404-3 are completed, without commencing the webpage sharing.

In operation 2403, the first electronic device 401 can transmit the webpage sharing data according to the connection with the second electronic devices 404-1, 404-2, and 404-3. The webpage sharing data can be transmitted by considering the connections between the first electronic device 401 and the second electronic devices 404-1, 404-2, and 404-3.

In operation 2405, the first electronic device 401 and the second electronic devices 404-1, 404-2, and 404-3 can share the webpage and exchange chatting messages. The chatting service can be supported by an application (e.g., a web browser) or a separate application. The chatting message can deliver a text message and media contents such as image, sound, or video. The chatting service can include realtime voice chatting or video chatting. For doing so, the first electronic device 401 and the second electronic devices 404-1, 404-2, and 404-3 can display an interface for the chatting. For example, the first electronic device 401 and the second electronic devices 404-1, 404-2, and 404-3 can display the interface for exchanging chatting messages as shown in FIG. 24C. Referring to FIG. 24C, the first electronic device 401 can share the webpage and concurrently exchange chatting messages with the second electronic devices 404-1, 404-2, and 404-3 in a chatting window 2412 of the application. Also, the second electronic devices 404-1, 404-2, and 404-3 can display the webpage of the first electronic device 401 through the application and concurrently interact with the other devices using the chatting in a chatting window 2422, 2432, and 2442 of the application.

In operation 2407, the first electronic device 401 can hand over sharing webpage control to the second electronic devices 404-1, 404-2, and 404-3. The webpage control can control the webpage which is shared. The first electronic device 401 initially has the webpage control, and then the second electronic devices 404-1, 404-2, and 404-3 can obtain the control. In operation 2409, the second electronic devices 404-1, 404-2, and 404-3 having the webpage control can control the webpage and share their webpage with another device.

According to an embodiment, an interface for managing the control is shown in FIG. 24D. Referring to FIG. 24D, the first electronic device 401, which is a master at first, controls the webpage and generates an event on the webpage. Next, the second electronic device 404-1 can obtain the master authority and share the webpage by controlling the webpage. An event of the webpage generated under the control of the second electronic device 401-1 can be processed by other devices including the first electronic device 401.

According to an embodiment, master information of the webpage control can be displayed through a separate window 2413, 2423, 2433, and 2443 of the application. The master can arbitrarily hand over the webpage control to the other device, or the master can be determined using a vote of the participating devices.

In various embodiments of the present disclosure, the webpage control can be given to two or more devices as well as one device. For example, bilateral control can be shared in real time. In this case, two or more devices can control several events on the webpage at the same time. For example, the devices can select and store data for processing the event shared in real time on the webpage. The devices can display the webpage by processing the webpage event in interactions with other devices, and display control objects including tools for interacting with other devices. The devices can determine a control order for interacting with other devices.

While the chatting message exchange of operation 2405 and the control management of operation 2407 are performed in sequence in FIG. 24A, operation 2405 and operation 2407 are independent of each other and can be conducted in a different order or at the same time. Also, only one of operation 2405 and operation 207 can be executed. For example, operation 2405 and operation 207 can be omitted.

Various embodiments of the present disclosure can provide examples of the webpage sharing. To follow a recipe in a webpage (e.g., a blog) including cooking contents, an application (e.g., a web browser) can display a webpage portion corresponding to each step of the cooking. For example, as the cooking steps proceed, the electronic device can scroll a corresponding webpage portion and display audio or a video in accordance with a webpage creator's intention. For example, the electronic device can video or record a situation of a webpage creator or a sharer, store events according to an important part (e.g., a microwave sound) designated by the webpage creator, and process the corresponding event in response to a similar situation of the second electronic device.

According to an embodiment, in an Internet personal sharing service (e.g., a streaming service), a user who watches the Internet personal sharing service can use not only the chatting but also the interaction function according to various embodiments of the present disclosure. For example, when a device of a viewer obtains webpage control, it can involve in the sharing service through scrolling, zooming, or note writing. When a plurality of devices obtains the webpage control, a plurality of hosts at difference places can share the Internet in turn.

According to an embodiment, in an online education service, devices joining in the online education service can share information about learning materials, lecture audio, or additional note for the online education. When sharing a webpage in real time or sharing a webpage stored, education contents can be created using the webpage without having to use a separate video and a teacher and students can communicate with each other during the education.

In various embodiments of the present disclosure, the webpage event data can be not only shared with another device but also processed by the device which stores the event. For example, the device can re-perform the event in a particular webpage. For example, when the user selects an item and an item option in a shopping mall site, a device which uses the shopping mall site can re-conduct a corresponding event and thus easily purchase a corresponding item. When a previous order is not completed due to a payment error, the device can easily re-perform the event.

According to various embodiments of the present disclosure, the electronic device can support a chatroom function based on a webpage title. For example, the electronic device can open a chatroom for devices which display the webpage through the same URL. According to an embodiment, devices which are friends of a Social Network Service (SNS) can display the same webpage through the same URL and concurrently use the chatting service by opening the chatroom. In so doing, the devices can use the chatting service without having to log on. According to another embodiment, when a certain number of posts are uploaded to a particular webpage during a certain time, a chatroom can be created. According to yet another embodiment, when the same webpage plays the same video, a chatroom for the chatting service between devices can be generated. According to still another embodiment, when other electronic devices which are stored in contacts of the electronic device access the same webpage, a chatroom can be created or a screen on the webpage can be shared. According to a further embodiment, when devices share a particular URL, data for opening a chatroom in a webpage corresponding to the URL can be shared. The chatroom open service may be provided as a unique function of applications (e.g., Samsung browsers), or as additional webpage contents.

The term “module” as used in the present disclosure can include a unit including hardware, software, or firmware, and can be interchangeably used with terms, for example, such as “logic”, “logical block”, “component”, “circuit”, and the like. “module” can be a minimum unit of an integral component or a minimum unit for performing one or more functions or a part thereof. “module” can be mechanically or electrically implemented. For example, “module” can include an Application-Specific Integrated Circuit (ASIC) chip, a Field-Programmable Gate Arrays (FPGAs), or a programmable-logic device, which are known or will be developed, for performing certain operations. At least part of a device (e.g., modules or functions thereof) or a method (e.g., operations) according to various embodiments can be implemented with instructions stored in a computer-readable storage medium (e.g., the memory 130) as a program module. When the instruction is executed by a processor (e.g., the processor 120), the processor can perform a function corresponding to the instruction. The computer-readable recording medium can include a hard disk, a floppy disk, magnetic media (e.g., a magnetic tape), optical media (e.g., a Compact Disc (CD)-Read Only Memory (ROM), a DVD), magneto-optical media (e.g., a floptical disk), and an internal memory. An instruction can include machine code made by a compiler or code executable by an interpreter. A module or a program module according to various embodiments can include at least one or more of the aforementioned components, omit some of them, or further include additional other components. Operations performed by a module, a program module, or other components according to various embodiments can be executed in a sequential, parallel, repetitive, or heuristic manner. At least some operations can be executed in a different order or be omitted, or other operations can be added.

According to various embodiments of the present disclosure, a method for sharing a webpage in an electronic device can include receiving data of a webpage through the communication circuit, displaying the webpage through the display, receiving an event on the webpage, generating data including information for generating the webpage, event information of the webpage, and event time information, and transmitting the generated data through the communication circuit. The event can include at least one of scroll, click, zoom-in, zoom-out, memo insertion, and audio recording with respect to the webpage. The information for generating the webpage can include at least one of a URL, an html resource, and contents of the webpage. The event information of the webpage can include a coordinate value of an object relating to the event and data relating to an event performed on the object, and include at least one of an object location value in the webpage and a DOM node value of the object. The event time information can include at least one of a time when the event occurs, a time elapsed from storing the event commences, and a time elapsed from a previous event. The method can include transmitting an address for sharing the event of the webpage and an ID of at least one other electronic device which is to receive the data, to a server connected with the electronic device through the communication circuit according to information of the data. The method can include receiving information for controlling the webpage from the at least one other electronic device through the communication circuit. The method can include executing a server program for the webpage sharing, and transmitting an address for sharing the event of the webpage and server information generated by the server program, to at least one other electronic device which is to receive the data, through the communication circuit. The data can further include a script of the event and a resource of the event. The data can further include a value indicating a width displaying the webpage in the electronic device.

According to various embodiments of the present disclosure, a method for sharing a webpage can include receiving data including information for generating the webpage, event information on the webpage, and event time information from another electronic device through the communication circuit, generating a webpage based on the data, and applying the event to the webpage according to the event time of the data. The event information of the webpage can include a coordinate value of an object relating to the event and data relating to an event performed on the object, and include at least one of an object location value in the webpage and a DOM node value of the object. The method can include rendering a webpage to display from the received data using an application, determining a location for processing the event on the webpage based on the object coordinate value, and processing an event of the webpage at the location at a time corresponding to the event. The method can include receiving an address for sharing the webpage and an ID of the one other electronic device from a server. The method can include receiving an address for sharing the webpage and information of a server configured by the other electronic device, from the other electronic device. The data further include a value indicating a width displaying the webpage in the other electronic device. The method can include comparing the width displaying the webpage in the other electronic device, with a width of the display, when the width displaying the webpage in the other electronic device is the same as the width of the display, laying out the webpage in the same width as the width displaying the webpage in the other electronic device, and, when the width displaying the webpage in the other electronic device is different from the width of the display, laying out the webpage according to the width of the display.

According to various embodiments of the present disclosure, the above-described methods can be implemented in software, firmware, hardware, or in their combinations.

As for the software, a computer-readable storage medium storing one or more programs (software modules) can be provided. One or more programs stored in the computer-readable storage medium can be configured for execution by one or more processors of the electronic device. One or more programs can include instructions for controlling the electronic device to execute the methods according to the exemplary embodiments of the present disclosure.

Such a program (software module, software) can be stored to a random access memory, a non-volatile memory including a flash memory, a Read Only Memory (ROM), an Electrically Erasable Programmable ROM (EEPROM), a magnetic disc storage device, a Compact Disc (CD)-ROM, Digital Versatile Discs (DVDs) or other optical storage devices, and a magnetic cassette. Alternatively, the programs can be stored to a memory combining part or all of those recording media. A plurality of memories may be equipped.

The programs can be stored in an attachable storage device accessible via a communication network such as Internet, Intranet, Local Area Network (LAN), Wide LAN (WLAN), or Storage Area Network (SAN), or a communication network by combining these networks. The storage device can access the electronic device through an external port. A separate storage device may access the electronic device over the communication network.

According to various embodiments of the present disclosure, a non-transitory computer readable medium can store instructions for webpage sharing. The instructions, when executed by a processor, can control the processor to receive data of a webpage through the communication circuit, to display the webpage through the display, to receive an event on the webpage, to generate data including information for generating the webpage, event information of the webpage, and event time information, and to transmit the generated data through the communication circuit. The event can include at least one of scroll, click, zoom-in, zoom-out, memo insertion, and audio recording with respect to the webpage. The information for generating the webpage can include at least one of a URL, an html resource, and contents of the webpage. The event information of the webpage can include a coordinate value of an object relating to the event and data relating to an event performed on the object, and include at least one of an object location value in the webpage and a DOM node value of the object. The event time information can include at least one of a time when the event occurs, a time elapsed from storing the event commences, and a time elapsed from a previous event. The instructions, when executed by the processor, can control the processor to transmit an address for sharing the event of the webpage and an ID of at least one other electronic device which is to receive the data, to a server connected with the electronic device through the communication circuit according to information of the data. The instructions, when executed by the processor, can control the processor to receive information for controlling the webpage from the at least one other electronic device through the communication circuit. The instructions, when executed by the processor, can control the processor to execute a server program for the webpage sharing, and to transmit an address for sharing the event of the webpage and server information generated by the server program, to at least one other electronic device which is to receive the data, through the communication circuit. The data can further include a script of the event and a resource of the event. The data can further include a value indicating a width displaying the webpage in the electronic device.

According to various embodiments of the present disclosure, a non-transitory computer readable medium can store instructions for webpage sharing. The instructions, when executed by a processor, can control the processor to receive data including information for generating the webpage, event information on the webpage, and event time information from other electronic device through the communication circuit, to generate a webpage based on the data, and to apply the event to the webpage according to the event time of the data. The event information of the webpage can include a coordinate value of an object relating to the event and data relating to an event performed on the object, and include at least one of an object location value in the webpage and a DOM node value of the object. The instructions, when executed by the processor, can control the processor to render a webpage to display from the received data using an application, to determine a location for processing the event on the webpage based on the object coordinate value, and to process an event of the webpage at the location at a time corresponding to the event. The instructions, when executed by the processor, can control the processor to receive an address for sharing the webpage and an ID of the one other electronic device from a server. The instructions, when executed by the processor, can control the processor to receive an address for sharing the webpage and information of a server configured by the other electronic device, from the other electronic device. The data further include a value indicating a width displaying the webpage in the other electronic device. The instructions, when executed by the processor, can control the processor to compare the width displaying the webpage in the other electronic device, with a width of the display, when the width displaying the webpage in the other electronic device is the same as the width of the display, to lay out the webpage in the same width as the width displaying the webpage in the other electronic device, and, when the width displaying the webpage in the other electronic device is different from the width of the display, to lay out the webpage according to the width of the display.

In the above-described various embodiments of the present disclosure, the elements included in the disclosure are expressed in a singular or plural form. However, the singular or plural expression is appropriately selected according to a proposed situation for the convenience of explanation and the present disclosure is not limited to a single element or a plurality of elements. The elements expressed in the plural form may be configured as a single element, and the elements expressed in the singular form may be configured as a plurality of elements.

Various embodiments of the present disclosure can provide a method and an electronic device for storing a continuous event based on time on a webpage.

Various embodiments of the present disclosure can provide a method and an electronic device for sharing data of a webpage.

Various embodiments of the present disclosure can provide a method and an electronic device for processing an event of a webpage in an application.

Various embodiments of the present disclosure can provide a method and an electronic device for interacting between users of devices which share a webpage.

The method and the electronic device according to various embodiments can achieve less data capacity, easy recipient participation, and free control in the sharing, compared to conventional video format sharing.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device for sharing a webpage, comprising:
a display;
a communication circuit;
a processor coupled to the communication circuit and the display; and
a memory coupled to the processor,
wherein the memory stores instructions, when executed, control the processor to:
receive data of a webpage through the communication circuit;
display the webpage through the display, receive an event on the webpage;
generate data including information for generating the webpage, event information of the webpage, and event time information; and
transmit the generated data through the communication circuit.

2. The electronic device of claim 1, wherein the event includes at least one of scroll, click, zoom-in, zoom-out, memo insertion, and audio recording with respect to the webpage.

3. The electronic device of claim 1, wherein the information for generating the webpage includes at least one of a Uniform Resource Locator (URL), a hypertext markup language (html) resource, and contents of the webpage.

4. The electronic device of claim 1, wherein the event information of the webpage includes a coordinate value of an object relating to the event and data relating to an event performed on the object, and includes at least one of an object location value in the webpage and a Document Object Model (DOM) node value of the object.

5. The electronic device of claim 1, wherein the event time information includes at least one of a time when the event occurs, a time elapsed from storing the event commences, and a time elapsed from a previous event.

6. The electronic device of claim 1, wherein the instructions further control the processor to transmit an address for sharing the event of the webpage and an Identifier (ID) of at least one other electronic device which is to receive the data, to a server connected with the electronic device through the communication circuit according to information of the data.

7. The electronic device of claim 6, wherein the instructions further control the processor to receive information for controlling the webpage from the at least one other electronic device through the communication circuit.

8. The electronic device of claim 1, wherein the instructions further control the processor to:
execute a server program for the webpage sharing; and
transmit an address for sharing the event of the webpage and server information generated by the server program, to at least one other electronic device which is to receive the data, through the communication circuit.

9. The electronic device of claim 1, wherein the data further includes a script of the event and a resource of the event.

10. The electronic device of claim 1, wherein the data further includes a value indicating a width displaying the webpage in the electronic device.

11. An electronic device for sharing a webpage, comprising:
a display;
a communication circuit;
a processor coupled to the communication circuit and the display; and
a memory coupled to the processor,
wherein the memory stores instructions, when executed, control the processor to:
receive data including information for generating the webpage, event information on the webpage, and event time information from one other electronic device through the communication circuit;
generate a webpage based on the data; and
apply an event to the webpage according to the event time of the data.

12. The electronic device of claim 11, wherein the event information of the webpage includes a coordinate value of an object relating to the event and data relating to an event performed on the object, and includes at least one of an object location value in the webpage and a Document Object Model (DOM) node value of the object.

13. The electronic device of claim 12, wherein the instructions further control the processor to:
render a webpage to display from the received data using an application;
determine a location for processing the event on the webpage based on the coordinate value of the object; and
process an event of the webpage at the location at a time corresponding to the event.

14. The electronic device of claim 11, wherein the instructions further control the processor to receive an address for sharing the webpage and an Identifier (ID) of the one other electronic device from a server.

15. The electronic device of claim 11, wherein the instructions further control the processor to receive an address for sharing the webpage and information of a server configured by the other electronic device, from the other electronic device.

16. The electronic device of claim 11, wherein the data further includes a value indicating a width displaying the webpage in the other electronic device.

17. The electronic device of claim 16, wherein the instructions further control the processor to:
compare the width displaying the webpage in the other electronic device, with a width of the display, when the width displaying the webpage in the other electronic device is the same as the width of the display;
lay out the webpage in the same width as the width displaying the webpage in the other electronic device; and
when the width displaying the webpage in the other electronic device is different from the width of the display, to lay out the webpage according to the width of the display.

18. A system for sharing a webpage, comprising:
a first electronic device for storing an event of the webpage;
a second electronic device for processing the event of the webpage; and
a server connected to the first electronic device and the second electronic device,
wherein the first electronic device displays the webpage, generates data including information for generating the webpage, event information of the webpage, and event time information, and transmits the generated data to the server,
the server receives the data from the first electronic device and transmits the data to the second electronic device, and
the second electronic device receives the data from the server, generates a webpage based on the data, and processes the event on the webpage according to the event time of the data.

19. The system of claim 18, wherein the first electronic device transmits an address for sharing the event of the webpage and an Identifier (ID) of the second electronic device which is to receive the data, to the server, and
the second electronic device receives the address for sharing the event of the webpage from the server, and receives the data using the address.

20. The system of claim 19, wherein the server performs a function for interaction between the first electronic device and the second electronic device, and
the function for the interaction includes at least one of text chatting, voice chatting, and Voice over Internet Protocol (VoIP) calls.
